(19) United States
(12) Patent Application Publication
(10) Pub. No.: US 2018/0225742 A1
(43) Pub. Date: Aug. 9, 2018

(54) ARTICLE INFORMATION DISPLAYING METHOD, APPARATUS AND SYSTEM, AND INTELLIGENT COMMUNICATION DEVICE

(71) Applicant: Alibaba Group Holding Limited, Georgetown (KY)

(72) Inventor: Xuemei HU, Hangzhou (CN)

(21) Appl. No.: 15/884,224

(22) Filed: Jan. 30, 2018

(30) Foreign Application Priority Data
Feb. 3, 2017 (CN) 201710063472.5

(51) Int. Cl. G06Q 30/06; H04M 1/725; G06F 3/0484

(52) U.S. Cl. CPC G06Q 30/0633; H04M 3/42059; G06F 3/04842; H04M 1/72519

(57) ABSTRACT

An article information displaying method, apparatus and system, and an intelligent communication device. The method comprises: displaying a telephone number used in current communication on a communication interface; acquiring order information associated with the telephone number used in current communication, wherein the order information comprises at least article information; and simultaneously displaying the telephone number used in current communication and the article information in a recognition window of the communication interface. The present invention solves the technical problem that a user cannot conveniently acquire information of an courier-delivered product before receiving the courier-delivered product.

### CROSS REFERENCE TO RELATED APPLICATIONS

This application claims priority to China Patent Application No. 201710063472.5, filed on Feb. 3, 2017, which is incorporated herein by reference in its entirety.

### TECHNICAL FIELD

The present invention relates to the field of Internet technologies, and in particular, to an article information displaying method, apparatus and system, and an intelligent communication device.

### BACKGROUND

Rapid development of Internet technologies brings a lot of conveniency for people's life, and one can purchase a product thousands miles away through the Internet while staying home. After a user purchases a product, a courier will deliver the purchased product to the user. Before receiving a phone call or a short message from the courier and opening a package, the user does not know the content of the package to be delivered by the courier. Moreover, after receiving a courier's short message that has a pick-up code, the user needs to open a short message application and click on the content of the short message in order to view the pick-up code information. Such an operating path is long for the user, and the operation is complicated. Besides, when receiving multiple information of pick-up codes, the codes may be mixed, leading to confusion. In addition, most mobile terminals cannot access the Internet when in use for a phone call; in other words, a user cannot acquire information of a delivered commodity during a call.

Currently no effective solution has been proposed to solve the problem that a user cannot conveniently acquire information of a courier-delivered product before receiving the product.

### SUMMARY

Embodiments of the present invention provide an article information displaying method, apparatus and system, and an intelligent communication device to solve at least the technical problem that a user cannot conveniently acquire information of a courier-delivered product before receiving the product.

According to an aspect of the embodiments of the present invention, an article information displaying method is provided, comprising: displaying a telephone number used in current communication on a communication interface of a user terminal; acquiring, by the user terminal, order information associated with the telephone number used in current communication, wherein the order information comprises at least article information; and simultaneously displaying the telephone number used in current communication and the article information on the communication interface of the user terminal, wherein the article information is displayed in a recognition window of the communication interface.

According to another aspect of the embodiments of the present invention, an article information displaying apparatus is further provided, comprising: a first displaying module, configured to display a telephone number used in current communication on a communication interface of a user terminal; an acquisition module, configured to be used by the user terminal to acquire order information associated with the telephone number used in current communication, wherein the order information comprises at least article information; and a second displaying module, configured to simultaneously display the telephone number used in current communication and the article information on the communication interface of the user terminal, wherein the article information is displayed in a recognition window of the communication interface.

According to another aspect of the embodiments of the present invention, an article information displaying system is further provided, comprising: a user terminal configured to display a telephone number used in current communication on a communication interface; a server having a communication relationship with a communication device and configured to obtain order information associated with the telephone number used in current communication through querying, and return the order information to the user terminal, wherein the order information comprises at least article information; and the user terminal being further configured to simultaneously display the telephone number used in current communication and the article information on the communication interface, wherein the article information is displayed in a recognition window of the communication interface.

According to another aspect of the embodiments of the present invention, an intelligent communication device is further provided, comprising: a display screen configured to provide a communication interface, and display a telephone number used in current communication on the communication interface; and a processor configured to acquire order information associated with the telephone number used in current communication, wherein the order information comprises at least article information; and the display screen being further configured to simultaneously display the telephone number used in current communication and the article information on the communication interface, wherein the article information is displayed in a recognition window of the communication interface.

According to another aspect of the embodiments of the present invention, an article information displaying method is further provided, comprising: displaying a telephone number used in current communication on a communication interface of a user terminal; capturing the telephone number used in current communication by using third-party application software installed in the user terminal; acquiring, by the third-party application software, order information associated with the telephone number used in current communication through accessing a corresponding order server, wherein the order information comprises at least article information; and displaying the telephone number used in current communication and the article information on the communication interface of the user terminal, wherein the article information is displayed in a recognition window of the communication interface.

According to another aspect of the embodiments of the present invention, an article information displaying apparatus is further provided, comprising: a fifth displaying module, configured to display a telephone number used in current communication on a communication interface of a user terminal; a capturing module, configured to capture the telephone number used in current communication by using third-party application software installed in the user terminal; an information acquisition module, configured to be used by the third-party application software to order information associated with the telephone number used in current communication through accessing a corresponding order server, wherein the order information comprises at least article information; and a sixth displaying module, configured to display the telephone number used in current communication and the article information on the communication interface of the user terminal, wherein the article information is displayed in a recognition window of the communication interface.

According to another aspect of the embodiments of the present invention, an information displaying method is further provided, comprising: acquiring a number for communication displayed on a communication interface of a user terminal; acquiring order information associated with the number for communication, wherein the order information comprises at least article information; and displaying the order information on the communication interface.

According to another aspect of the embodiments of the present invention, an information displaying apparatus is further provided, comprising: a fourth acquisition module, configured to acquire a number for communication displayed on a communication interface of a user terminal; a fifth acquisition module, configured to acquire order information associated with the number for communication, wherein the order information comprises at least article information; and a sixth displaying module, configured to display the order information on the communication interface.

In the embodiments of the present invention, by means of information comparison, a telephone number used in current communication is displayed on a communication interface; order information associated with the telephone number used in current communication is acquired; and the telephone number used in current communication and article information are displayed simultaneously in a recognition window of the communication interface, wherein the order information includes at least the article information, thereby achieving the objective of acquiring information of a courier-delivered product for a user before the user receiving the product. By displaying the calling telephone number and the article information on the communication interface, the present invention improves user experience, achieves its technical effect, and further solves the technical problem that a user cannot conveniently acquire information of a courier-delivered product before receiving the product.

### BRIEF DESCRIPTION OF THE DRAWINGS

The accompanying drawings described herein are used to provide further understanding of the present invention, and construct a part of the present application. Exemplary embodiments of the present invention and illustrations thereof are used to explain the present invention, but are not intended to form any improper limitation on the present invention. In the drawings:

FIG. 1 is a schematic diagram of an optional display interface according to the prior art;

FIG. 2 is a flowchart of an article information displaying method according to an embodiment of the present invention;

FIG. 3 is a schematic diagram of an optional communication interface of a user terminal according to an embodiment of the present invention;

FIG. 4 is a schematic diagram of an optional display interface of logistics information according to an embodiment of the present invention;

FIG. 5 is a flowchart of an optional article information displaying method according to an embodiment of the present invention;

FIG. 6 is a flowchart of an optional article information displaying method according to an embodiment of the present invention;

FIG. 7 is a flowchart of an optional article information displaying method according to an embodiment of the present invention;

FIG. 8(a) is a schematic diagram of an optional display interface in an unlocked state according to an embodiment of the present invention;

FIG. 8(b) is a schematic diagram of an optional display interface of a missed call according to an embodiment of the present invention;

FIG. 8(c) is a schematic diagram of an optional display interface of a missed call according to an embodiment of the present invention;

FIG. 8(d) is a schematic diagram of an optional display interface of a missed call according to an embodiment of the present invention;

FIG. 9 is a flowchart of an optional article information displaying method according to an embodiment of the present invention;

FIG. 10(a) is a schematic diagram of an optional display interface of short message information including a pick-up code according to an embodiment of the present invention;

FIG. 10(b) is a schematic diagram of an optional display interface of short message information not including a pick-up code according to an embodiment of the present invention;

FIG. 11 is a flowchart of an optional article information displaying method according to an embodiment of the present invention;

FIG. 12 is a schematic structural diagram of an article information displaying apparatus according to an embodiment of the present invention;

FIG. 13 is a schematic structural diagram of an article information displaying system according to an embodiment of the present invention;

FIG. 14 is an interaction diagram of an optional system for subscribing a logistics state change notification according to an embodiment of the present invention;

FIG. 15 is an interaction diagram of an optional system for subscribing a logistics state change notification according to an embodiment of the present invention;

FIG. 16 is a schematic structural diagram of an intelligent communication device according to an embodiment of the present invention;

FIG. 17 is a structural block diagram of a computer terminal according to an embodiment of the present invention;

FIG. 18 is a flowchart of an article information displaying method according to an embodiment of the present invention;

FIG. 19 is a flowchart of an optional article information displaying method according to an embodiment of the present invention;

FIG. 20 is a flowchart of an optional article information displaying method according to an embodiment of the present invention;

FIG. 21 is a schematic structural diagram of an article information displaying apparatus according to an embodiment of the present invention;

FIG. 22 is a flowchart of an information displaying method according to an embodiment of the present invention;

FIG. 23 is a flowchart of an optional information displaying method according to an embodiment of the present invention; and

FIG. 24 is a schematic structural diagram of an information displaying apparatus according to an embodiment of the present invention.

### DETAILED DESCRIPTION

In order to make those skilled in the art better understand the solutions in the present invention, the technical solutions in the embodiments of the present invention will be described clearly and completely with reference to the accompanying drawings in the embodiments of the present invention. As can be appreciated by those of ordinary skill in the art, the described embodiments are merely some rather than all of the embodiments of the present invention. Based on the embodiments of the present invention, all other equivalent embodiments derived by those of ordinary skill in the art shall fall within the protected scope of the present invention.

It should be noted that terms such as “first” and “second” in the description, claims, and accompanying drawings of the present invention are used for distinguishing similar objects, and are unnecessarily used to describe particular orders or sequences. It should be understood that data used in such way may be exchanged in a suitable case, such that the embodiments of the present invention described here can be implemented in an order other than the orders shown or described here. Moreover, terms “include” and “have”, as well as any variations thereof, are intended to cover non-exclusive inclusion. For example, a process, method, system, product, or device including a series of steps or units does not need to be limited to those steps or units clearly listed, but can include other steps or units that are not clearly listed or inherent to the process, method, product, or device.

### Embodiment 1

The embodiments of the present invention provide an embodiment of an article information displaying method. It should be noted that steps shown in a flowchart of the accompanying drawings may be performed in a computer system as a group of computer executable instructions. Moreover, although a logical order is shown in the flowchart, in some cases, the steps shown or described may be performed in a different order.

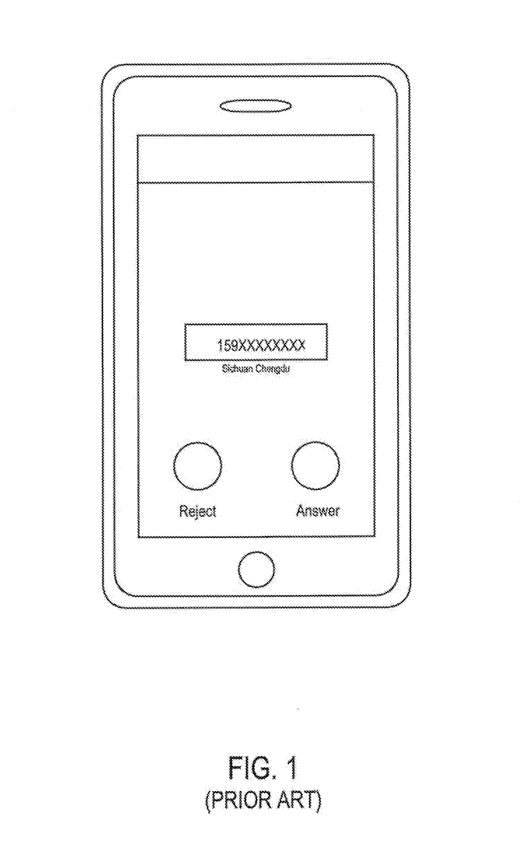

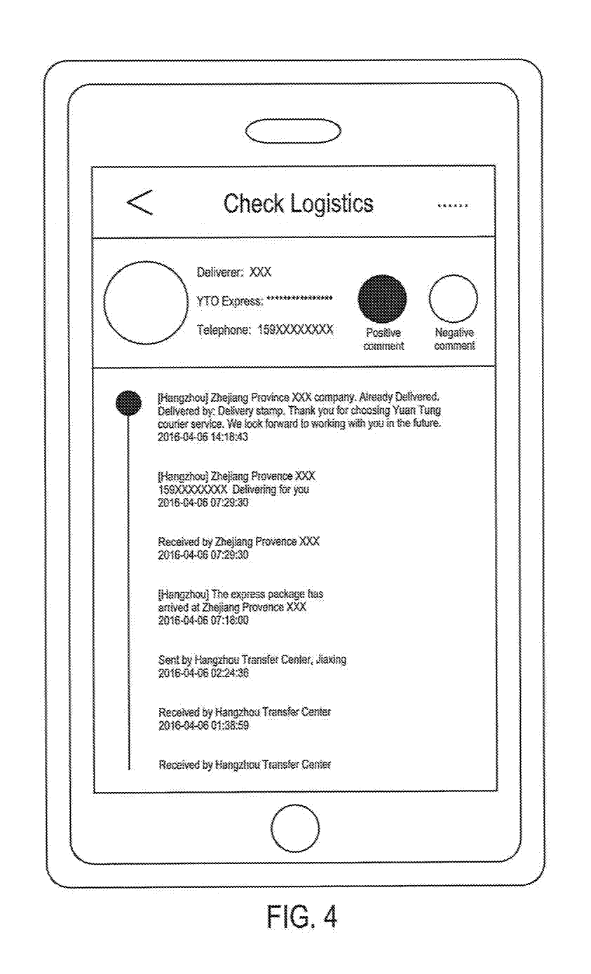

The method embodiment provided in Embodiment 1 of the present application is broadly applicable to the field of Internet. With rapid development of Internet technologies, Internet becomes inevitable for people's life, study, and work. The Internet provides great convenience for people's life. For example, one can buy favored clothing and enjoy delicious foods made at different places while staying home. Commodities purchased by people through the Internet are ever increasing. When a courier calls a person to remind him/her to pick up a package, the person can merely obtain a telephone number of the courier through a display screen of a mobile terminal (e.g., a mobile phone), as shown in FIG. 1, a prior art schematic diagram of a display interface of a mobile phone user answering a call of a courier. To view logistics information of a purchased commodity and the commodity state (for example, the delivery state), it is necessary for a user to log into a client application (e.g., a JingDong client terminal) to query the logistics information, so as to determine which packages that needs signature when being delivered, as shown in FIG. 4. FIG. 4 is a schematic diagram of an interface for a user to view logistics information in accordance with the present invention. When a courier notifies a user of relevant information (such as a pick-up code and a pick-up address) of a courier package through a short message, the user needs to open the short message first before viewing the relevant information; and operating steps are complicated. Moreover, when the mobile terminal of the user is in a calling state, the mobile terminal is not connected to the Internet. In this case, the user cannot acquire the information of the commodity obtained through the Internet.

In the present invention, when the user receives a call from the courier, not only the telephone number of the courier, but also order information and logistics information of the commodity can be displayed on the mobile terminal (e.g., the mobile phone) of the user. Therefore, it is unnecessary for the user to log into the client application to view the order information and the logistics information of the commodity. If the courier notifies the user of the logistics information of the commodity by using a short message, information such as a pick-up code and a pick-up address of the commodity is directly displayed on the display interface of the mobile terminal. In the present invention, order information and logistics information of a commodity are cached offline; and therefore, when a mobile terminal of a user is not connected to the Internet when making a phone call to a courier, the order information, the logistics information, and so on of the commodity can still be displayed on a display interface of the mobile terminal. Moreover, the present invention may further set up the displaying of a commodity; for example, the mobile terminal may display information of a sensitive commodity after carrying out a desensitized processing.

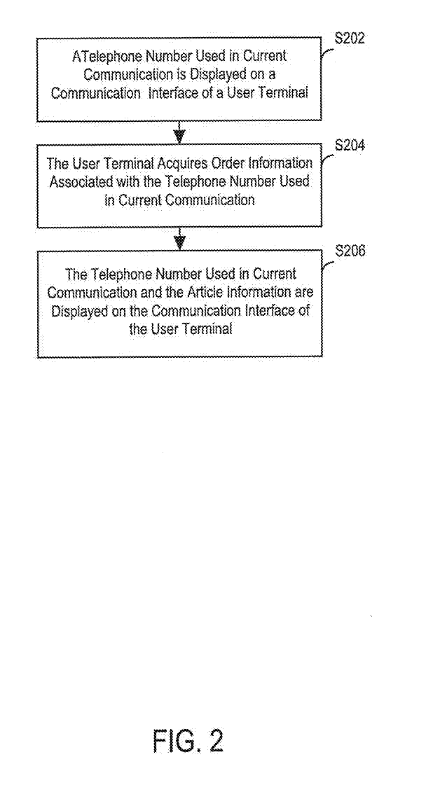

According to the embodiments of the present invention, an embodiment of an article information displaying method is provided. FIG. 2 is a flowchart of an article information displaying method according to an embodiment of the present invention. As shown in FIG. 2, the method includes the following steps:

Step S202: A telephone number used in current communication is displayed on a communication interface of a user terminal.

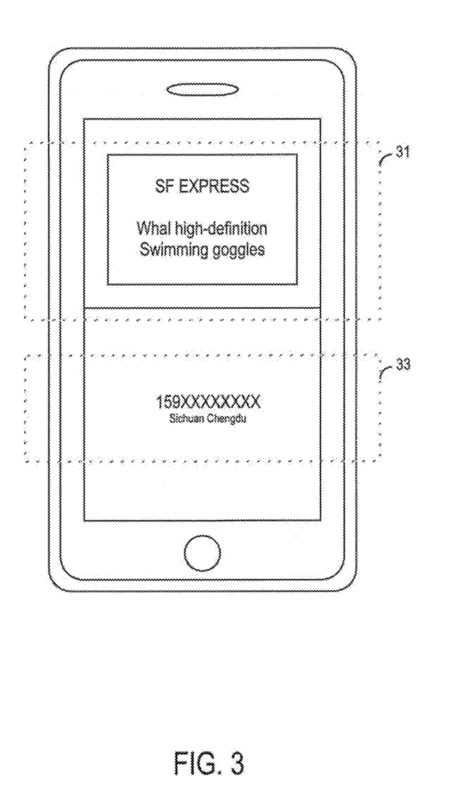

In the step S202, the user terminal may be, but is not limited to, a hand-held device, a wearable device, and the like, or a smartphone and a tablet. When the user terminal is a smart phone, the communication interface of the user terminal may be the display interface used for making a call; and may also be a display interface of other means used by the user for communication. Other means may include, but are not limited to, short message, WeChat, QQ, and other means. FIG. 3 shows a schematic diagram of a communication interface of a user terminal. As shown in FIG. 3, the telephone number displayed on the display interface is the telephone number currently used for communicating with the user.

It should be noted that the telephone number used in current communication has been recorded at some websites, and has some special marks. For example, FIG. 4 shows an optional display interface of logistics information. A telephone number displayed in FIG. 4 has been recorded in logistics information of a commodity purchased by a user; and the telephone number is marked as the telephone number of a commodity deliverer in the logistics information.

Step S204: The user terminal acquires order information associated with the telephone number used in current communication, wherein the order information includes at least article information.

In an optional embodiment, the telephone number used for the current communication is a telephone number of a courier who delivers goods for the user. When the courier makes a phone call to the current user or the call has gone through but has not been answered, a terminal device (e.g., a smart phone) held by the user may acquire, through the received telephone number, order information associated with the telephone number. Specifically, when the terminal device held by the user receives a call notification of the courier (at this time, the call has not gone through yet), the terminal device held by the user acquires a JingDong account of the user, obtains information of goods purchased by the user, i.e., order information, according to the JingDong account of the user and the telephone number of the courier, and displays the order information on a display interface of the terminal device held by the user.

It should be noted that the article information comprises at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

Step S206: The telephone number used in current communication and the article information are displayed on the communication interface of the user terminal, wherein the article information is displayed in a recognition window of the communication interface.

In an optional embodiment, after acquiring the telephone number used in current communication and the article information corresponding to the telephone number, the user terminal simultaneously displays the telephone number and the article information in the recognition window of the communication interface of the user terminal. In the interface shown in FIG. 3, dashed box 31 is an article information region in the recognition window, and dashed box 33 is a display region of the telephone number in the recognition window.

Optionally, if the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity comprises a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

By using the step S206, the user can view the current calling telephone number and information of the goods corresponding to the telephone number by using the communication interface of the user terminal. That is, when receiving a call or a short message from a courier, the user can know relevant information of the commodity delivered by the courier before opening the package.

Based on the solution disclosed from step S202 to step S206 in the above embodiment, it can be appreciated that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

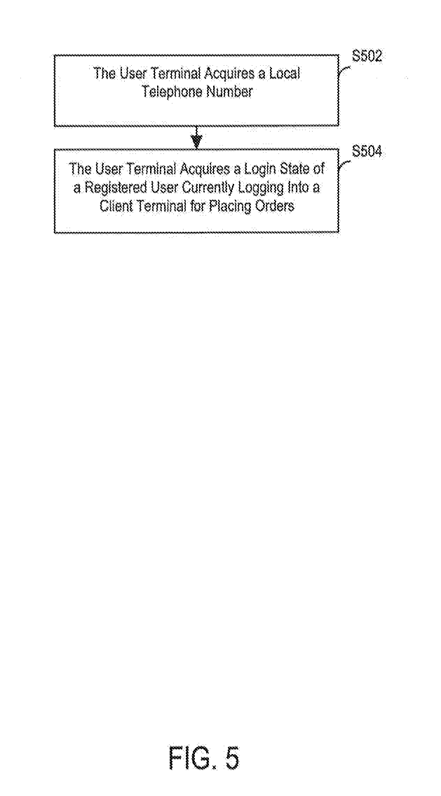

Optionally, according to an embodiment of the present invention, a flowchart of an article information displaying method is provided. As shown in FIG. 5, before the user terminal acquires the order information associated with the telephone number used in current communication, the method further includes the following steps:

Step S502: The user terminal acquires a local telephone number, wherein the local telephone number is combined with the telephone number used in current communication to determine the order information; or,

Step S504: The user terminal acquires a login state of a registered user currently logging into a client terminal for placing orders, wherein if the login state indicates a successful login, order information for an order delivered to the registered user is queried, wherein the client terminal for placing orders is a client application installed in the user terminal.

In an optional embodiment, the article information is stored or cached in the user terminal, wherein the telephone number of the deliverer is included in the article information stored or cached. For example, a user purchases a woollen shawl from JD.com; and at this time, a user terminal stores information of the commodity purchased by the user and updates logistics information of the woollen shawl in real time. When a courier starts the delivering process of the commodity for the user, the user terminal stores delivery information, wherein the delivery information includes at least a telephone number of the courier and a name of the to-be-delivered courier package. When the courier notifies the user to pick up the courier package, the user terminal compares the received telephone number of the courier with the stored telephone number of the courier who delivers the purchased commodity; and if the telephone numbers match and the commodity is not a sensitive commodity, the user terminal displays commodity information corresponding to the courier in a recognition window of the user terminal. At this time, if it is detected that the commodity is a sensitive commodity, commodity information after being desensitized is displayed in the recognition window of the user terminal.

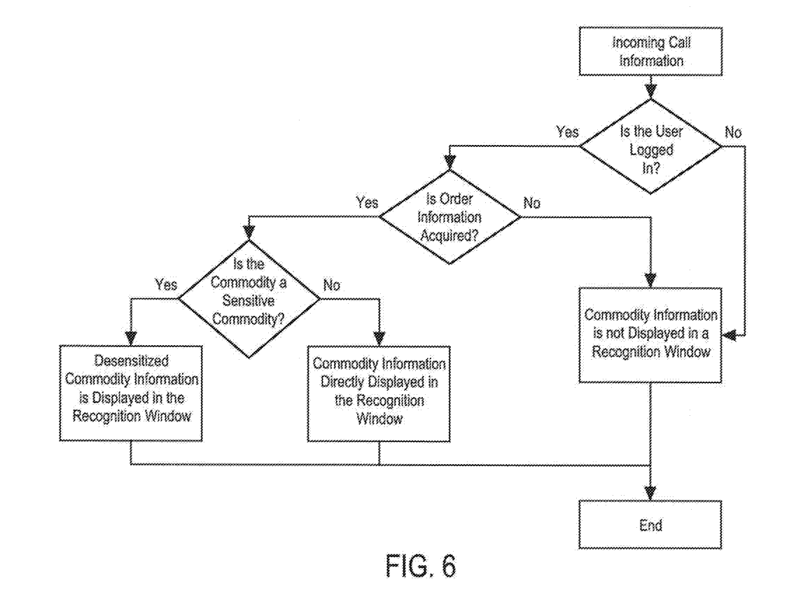

FIG. 6 shows a flowchart of an optional article information displaying method of the present invention. As shown in FIG. 6, in another optional embodiment, a user terminal (e.g., a smartphone) is installed with a client terminal for placing orders (e.g., a Jingdong client terminal). When the smartphone of a user detects information of an incoming call, a processor of the smartphone first judges whether a registered user of the Jingdong client terminal is in a login state. If the smartphone detects that the Jingdong client terminal is in a login state, the smartphone acquires order information of the registered user from logistics information of a commodity of the Jingdong client terminal according to a telephone number communicating with the smart phone. If the order information is not acquired, commodity information is not displayed; otherwise, information such as the commodity name is extracted from the order information; and it is determined whether the commodity is a sensitive commodity according to the information such as the commodity name. If the commodity is a sensitive commodity, commodity information after being desensitized is displayed in a recognition window of the smart phone. If the commodity is not a sensitive commodity, the usual commodity information is displayed in the recognition window of the smart phone.

It should be noted that the client terminal for placing orders may be, but is not limited to, a shopping client terminal (such as Jingdong and Suning), and a client terminal for ordering food (such as Meituan and Baidu Nuomi). The registered user of the client terminal for placing orders is not limited to the owner of the user terminal, and may also be another registered user having a registered account with the client terminal for placing orders.

On the basis of the method flowchart shown in FIG. 6, another optional embodiment is provided. If the smartphone detects that the login state of the Jingdong client terminal indicates an unsuccessful login or does not find information associated with the telephone number of the incoming call by querying the order information of the client terminal for placing orders, the smartphone acquires logistics information of a plurality of commodities from a third-party server, and compares the telephone number of the incoming call with telephone numbers of couriers in the logistics information of the plurality of commodities. If the two telephone numbers match, information of the commodity associated with the telephone number of the incoming call is acquired; and the information is displayed in the recognition window of the smart phone. If it is detected that the commodity is a sensitive commodity, commodity information after being desensitized is displayed in the recognition window of the smart phone. It should be noted that in the above embodiment, the third-party server is a server other than the Jingdong server. That is, the third-party server is a server other than a server of the client terminal for placing orders.

Moreover, if the user terminal has poor network signal reception, and cannot return acquired commodity information in time, it is judged whether a time interval between receiving the incoming call by the user terminal and the displaying of the recognition window is greater than a preset time length (e.g., 5 s). If the time interval is greater than the preset time length, only a call type (e.g., a China Mobile user) is displayed on the communication interface of the user terminal without commodity information. If the user terminal acquires the commodity information, but the picture of the commodity is loaded slowly due to the slow speed of the Internet, in this case, only a default base map (i.e., a gray image having low pixels) is displayed in the recognition window of the user terminal.

Optionally, after the telephone number used in current communication and the article information are displayed simultaneously on the communication interface of the user terminal, the article information displaying method further includes the following step:

Step S602: The user terminal performs a clicking operation on the recognition window of the communication interface; acquires order information associated with the recognition window; and displays the order information in a new pop-up interface, wherein the order information further comprises at least logistics information of the order. If the article information has a predetermined type of information, the predetermined type of information in the article information is deleted, shielded, or encrypted.

In an optional embodiment, after the user clicks on the commodity information shown by the dashed box 31 in FIG. 3 in which a communication interface of the user terminal is shown, a new display interface is popped up on the communication interface of the user terminal, and the logistics information of the commodity shown in FIG. 4 is displayed on the new pop-up display interface. If the category in commodity information (i.e., article information) of the commodity belongs to a predetermined type, the commodity information of the commodity is not displayed on the display interface; only the logistics information is displayed.

It should be noted that the information of the predetermined type is information of a sensitive commodity type. The user terminal may judge whether the commodity belongs to the category of sensitive commodities by examining the commodity category. The user terminal may also recognize a commodity name, extract a keyword in the commodity name, and detect whether the keyword is a sensitive keyword (a keyword indicating that the commodity is a sensitive commodity). If the commodity name includes the sensitive keyword, the commodity is determined as a sensitive commodity. Moreover, the sensitive commodity may include, but is not limited to, the following types:
Clothing: Sexy underwear, bra, underpants;
Maternal and infant: Motherhood necessities, underwear, underpants;
Skin care and makeup: Slimming and body shaping, breast treatment, slimming, body shaping, breast care, waxing;
Adult products.

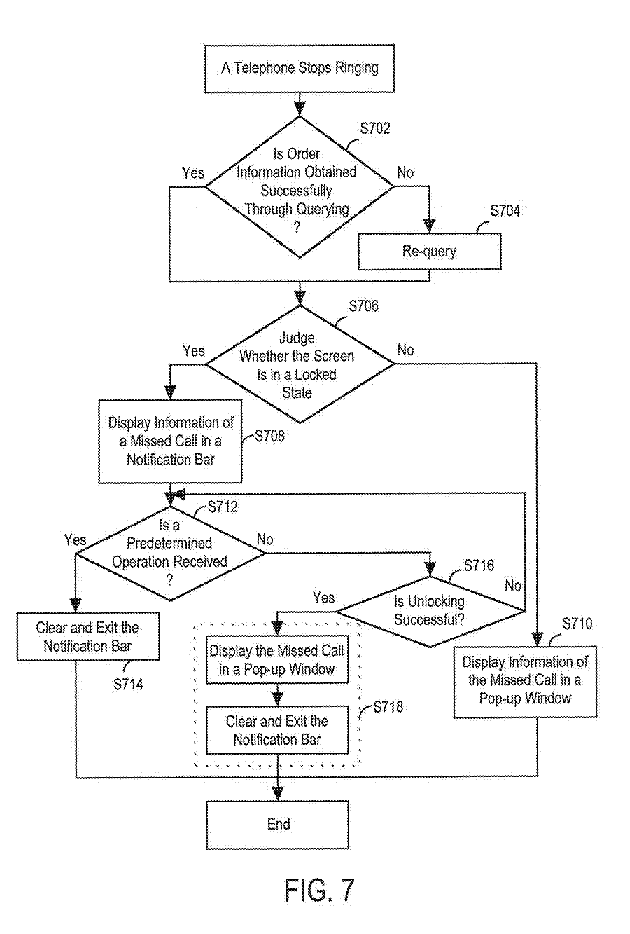

Optionally, FIG. 7 shows a flowchart of an optional article information displaying method. As shown in FIG. 7, a communication interface is a call interface, and a calling telephone stops ringing and enters a missed-call state. That is, a missed call appears on a user terminal. After a telephone number used in current communication is displayed on the communication interface, the method further includes the following steps:

Step S702: The user terminal judges whether order information associated with the telephone number is obtained successfully through querying, and if the query fails, step S704 is performed; otherwise, step S706 is performed.

Step S704: The user terminal re-queries order information associated with the telephone number used in current communication, wherein a re-query frequency is less than or equal to a predetermined number, and/or a time length consumed in re-querying is less than or equal to a predetermined time length (e.g., 5 s).

It should be noted that the predetermined time length refers to a time length from the time when ringing of the telephone stops to the time when a query result is returned for the first time. The time length further includes a time for the user terminal to be re-connected to the Internet after the ringing stops.

Step S706: It is judged whether a screen for displaying the communication interface is in a locked state, and if the screen is in a locked state, step S708 is performed; otherwise, step S710 is performed.

Step S708: Information of a missed call is displayed in a notification bar, and step S712 is performed after the information of the missed call is displayed in the notification bar.

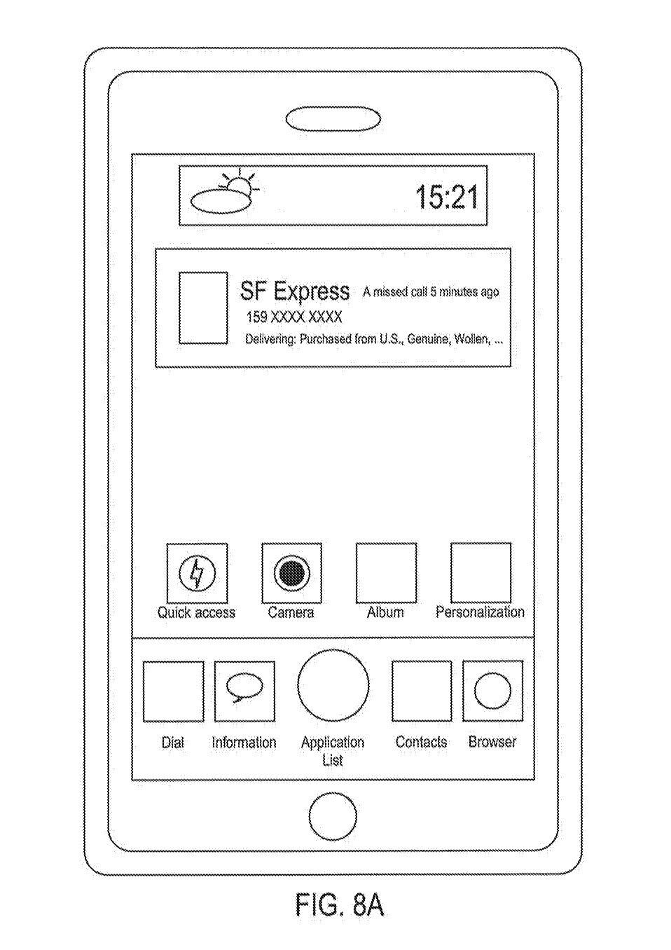

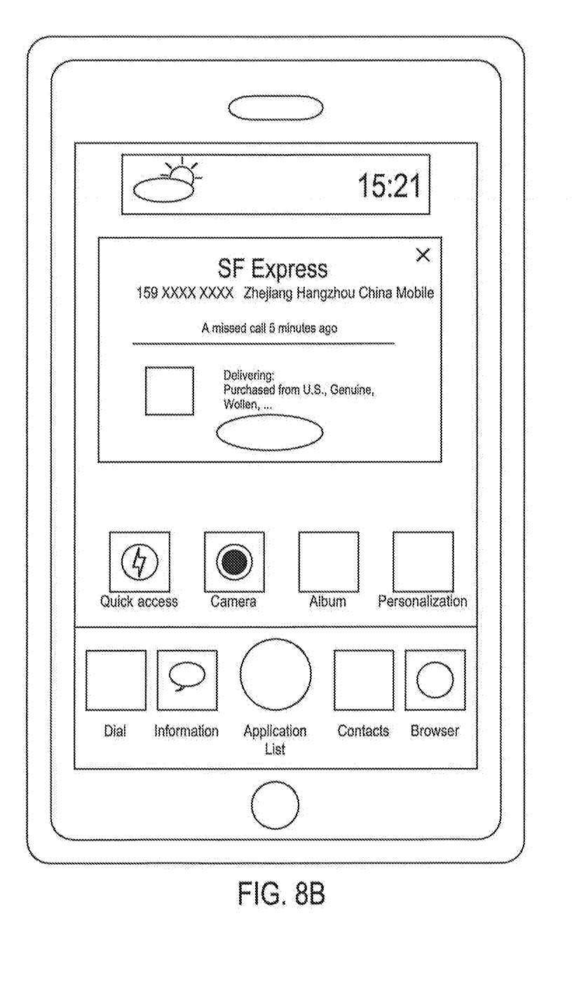

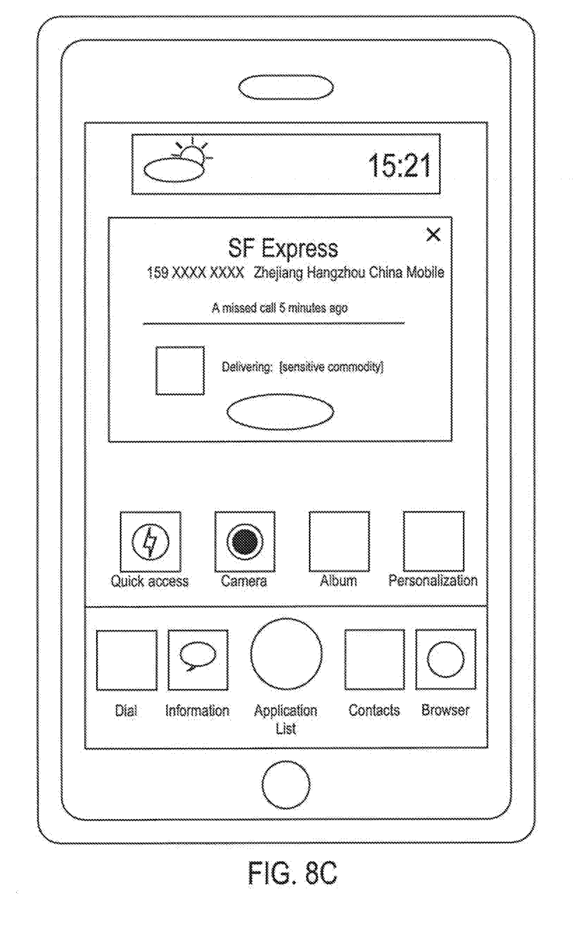

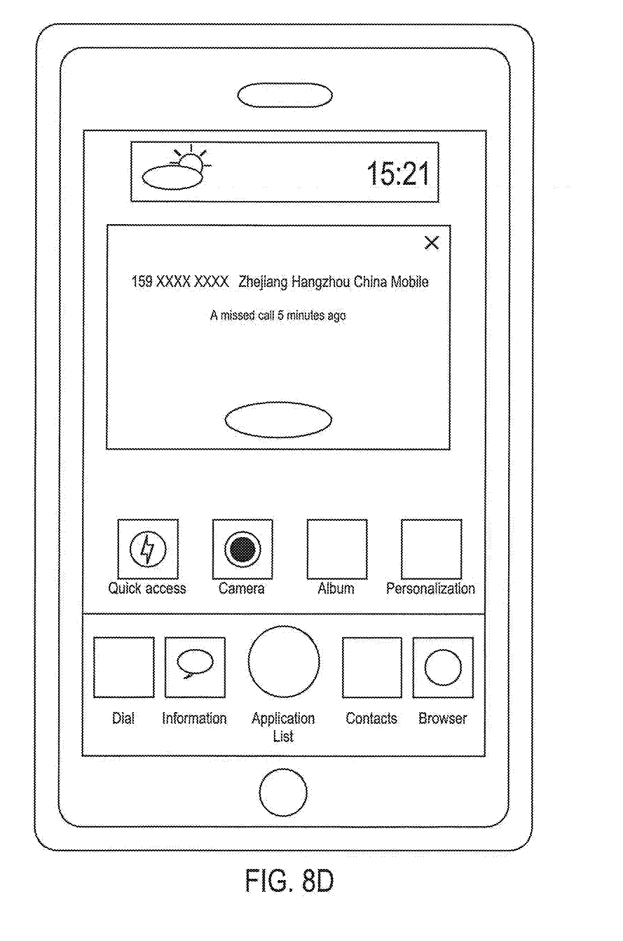

Step S710: The information of the missed call is displayed in a pop-up window, and the procedure ends. FIG. 8(a) shows an optional display interface in an unlocked state; and information of a commodity delivered by a courier and a telephone number of the courier are displayed on the display interface. FIG. 8(b) is a schematic diagram of a display interface of a missed call in a normal situation. FIG. 8(c) is a schematic diagram of a display interface when a commodity is a sensitive commodity. FIG. 8(d) is a schematic diagram of a display interface when no order information is queried.

Step S712: It is detected whether a touch screen with the notification bar located therein receives a predetermined operation, wherein the predetermined operation includes clicking on information of a missed call, sliding on the call information, and ignoring the call information (i.e., clicking on an ignore button on the display interface). When the user clicks on the missed call information, the user is redirected to a dialing interface and a telephone number to be dialed is displayed on the touch screen. When the user slides on the call information, the information of the missed call may disappear. If the user clicks on the ignore button on the touch screen, the information of the missed call will be retained on the display interface of the user terminal until the user clicks or slides on the missed call information. If the user terminal detects the predetermined operation, step S714 is performed; otherwise, step S716 is performed.

Step S714: Clear or exit the notification bar.

Step S716: It is judged whether the screen is unlocked successfully; and if the screen is unlocked successfully, step S718 is performed; otherwise, step S712 is performed.

Step S718: The missed call is displayed in a pop-up window, and the notification bar is cleared, or exiting the notification bar.

Optionally, if the notification bar displays information of a plurality of missed calls, it is judged whether abnormal information exists in the information for the plurality of missed calls.

Specifically, if a plurality of missed calls exist, and the plurality of missed calls are telephone numbers of the same courier, only the last call information of the courier is displayed. If the plurality of missed calls are telephone numbers of multiple couriers, information of the missed calls is displayed sequentially in the notification bar, and the information of the plurality of missed calls may also be displayed in layered pop-up windows.

It should be noted that for a sensitive commodity, commodity information after being desensitized is displayed in the notification bard.

In an optional embodiment, refreshing the time when a missed call occurs include the following modes:

(1) Constantly refreshing the time when a missed call occurs.

(2) Refreshing the time when a missed call occurs when the screen is unlocked.

(3) Not displaying the time interval between the time when a missed call occurs and the current time; the specific time is displayed instead. For example, rather than showing “A missed call 5 minutes ago” on the communication interface, “A call is missed at 12:23:22 2016-8-9” is displayed.

(4) No refreshing performed.

Moreover, different user terminals might have different functions. For example, systems of Android 4.0 and lower may not be able to customize a notification message; that is, they cannot display relevant information of a missed call; only a telephone number can be displayed.

It should be noted that in order to ensure that information of a missed call is effectively displayed for a user who cannot access the Internet during a call (including the situation where a call has not been got through) and the user terminal cannot query the information of the missed call (for example, the current user terminal cannot acquire a wireless network or a mobile telecommunication data network, or network signals are weak, or the like), after the user terminal stops ringing, it is necessary to query the order condition again.

Moreover, it should be further noted that missed calls might include the following types of calls. The types of calls and their respective supported operations are shown in Table 1.

TABLE 1

| Types of missed | | |
|---|---|---|
| call prompts | Content types | Supported operation |
| Notification | Having normal package | Click: redirect to a dialing interface |
| message | information | (with a number inputted already) |
| | Having private package | Slide: disappear |
| | information | Ignore: retain |
| | No package information | |
| Pop-up window | Having normal package | Click dialing: redirect to a dialing |
| prompt | information | interface (with a number inputted |
| | Having private package | already) |
| | information | Click close: close the pop-up window |
| | No package information | Click return, home: the pop-up |
| | | window disappears |
| | | Click blank: retain |

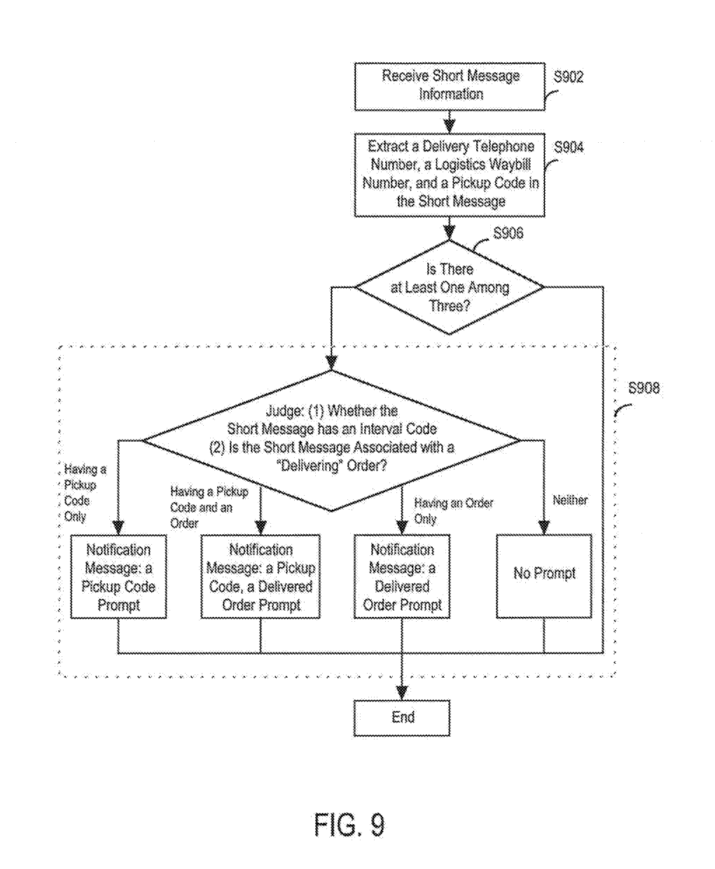

Optionally, FIG. 9 shows a flowchart of an optional article information displaying method. As shown in FIG. 9, after the telephone number used in current communication and the article information are displayed simultaneously in the recognition window of the communication interface, the method further includes:

Step S902: Receive short message information, wherein the short message is a courier short message. Specifically, a user terminal may determine whether the short message is a short message for a courier service by judging a source of the short message; and the user terminal may also determine whether the short message is a short message for a courier service by judging whether numerals included in the short message are a number for a courier service.

Step S904: At least one or more types of order information as follows are extracted from the short message information: article information, pick-up information, and courier information. The article information includes at least a goods name, detail information (e.g., model, and size) of goods, and the like. The pick-up information includes at least a pick-up code, a pick-up address, and the like. The courier information includes at least a courier service waybill number, a courier service company, contact information of a courier, and the like.

Step S906: It is determined, according to the order information, whether an order meets at least one predetermined condition; and if so, step S908 is performed; otherwise, the procedure ends.

Step S908: A corresponding notification message is acquired, wherein the notification message carries different prompt information.

In an optional embodiment, it is first judged whether the short message information includes a pick-up code and whether the short message information is associated with the order information. Whether the short message information is associated with the order information may be judged in the following manner: if order information does not exist, it is preferred to query using a courier service waybill number; and if a courier service waybill number included in the short message information is the same as the courier service waybill number included in the order information, the short message information is associated with the order information. Alternatively, when only the courier service waybill number exists in the short message information, then an ID number of a client application is used for query, and a courier service waybill number in the application client terminal is compared with the courier service waybill number in the short message information. If the two telephone numbers match, the short message information is associated with the order information.

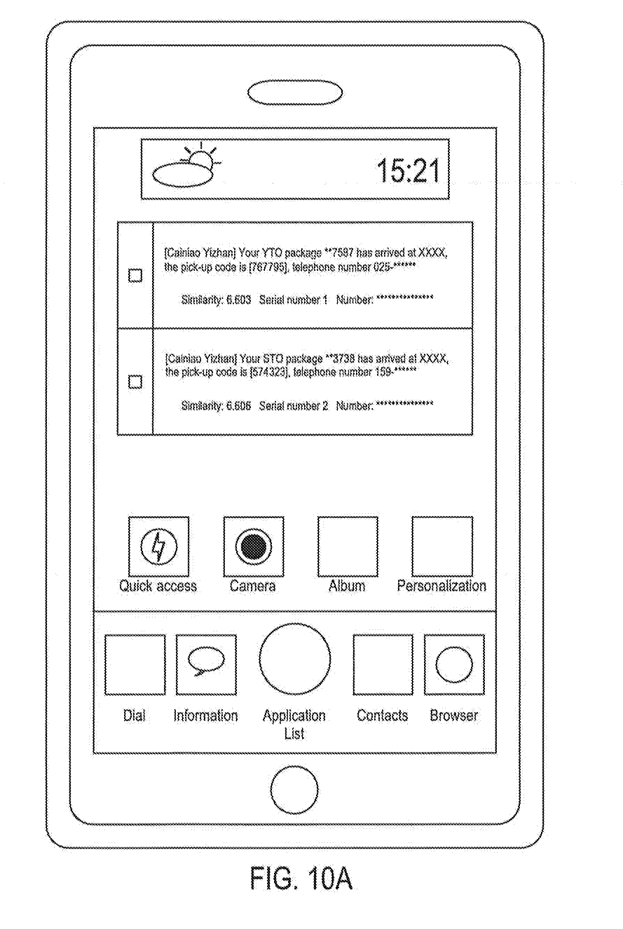

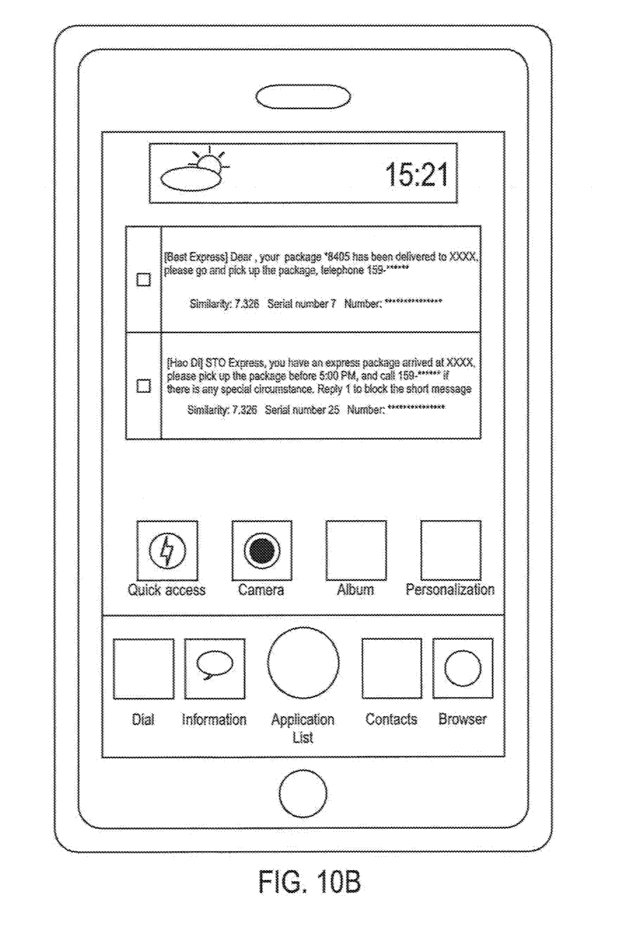

When the short message information is associated with the order information and if only the pick-up code exists in the short message information, the prompt information in the notification message is pick-up code prompt information. If both the pick-up code and the courier service waybill number exist in the short message information, the prompt information in the notification message includes pick-up code prompt information and to-be-delivered order prompt information. If only the courier service waybill number exists in the short message information, the prompt information in the notification message includes to-be-delivered order prompt information. If both pick-up code and courier service waybill number do not exist in the short message information, no message is prompted. FIG. 10(a) shows a schematic diagram of an optional display interface in which short message information includes a pick-up code. FIG. 10(b) shows a schematic diagram of an optional display interface in which short message information does not include a pick-up code.

It should be noted that for a sensitive commodity, commodity information after being desenzitized is displayed on the display interface of the user terminal.

Moreover, it should be further noted that from the time that a short message of courier information is received to the time the information is displayed on the display interface of the user terminal is a network request process. In the absence of a network connection, when extracting the short message information, the priority of extracting the short message information is higher than the priority of judging whether it is a local fraud.

Table 2 shows relationships between courier information prompt types and presentation information.

TABLE 2

| Courier information prompt type | Presentation information and source |
|---|---|
| Notification: having a pick-up | Courier service company: text in [ ] |
| code only | Pick-up code: text recognition |
| | Company of a deliverer: text associated with a |
| | telephone number |
| | Number of the deliverer: text recognition |
| Notification: having a pick-up | Courier service company: text in [ ] |
| code and an associated order | Pick-up code: text recognition |
| | Package picture: first commodity picture of the order |
| | Package content: first commodity content of the order |
| | Company of the deliverer: text associated with a |
| | telephone number |
| | Number of the deliverer: text recognition |
| Notification: having no pick-up | Courier service company: text in [ ] |
| code, but having an associated | Package picture: first commodity picture of the order |
| order | Package content: first commodity content of the order |
| | Company of the deliverer: text associated with a |
| | telephone number |
| | Number of the deliverer: text recognition |

Optionally, if a plurality of successive pieces of short message information are received, the plurality of pieces of short message information are displayed in the notification bar; and if a plurality of pieces of short message information having identical content are received, only one of the plurality of pieces of short message information is displayed.

Specifically, when the user terminal receives a plurality of different pieces of short message information about the courier service, the notification bar of the user terminal displays all the courier service short message information. If the received plurality of pieces of short message information about the courier service include identical courier service short message information, only the last piece of courier service short message information is displayed. If the received courier service short message information includes content such as “received”, the user terminal updates a received state on the display interface of the user terminal.

It should be noted that for a sensitive commodity, commodity information after being desensitized is displayed on the display interface.

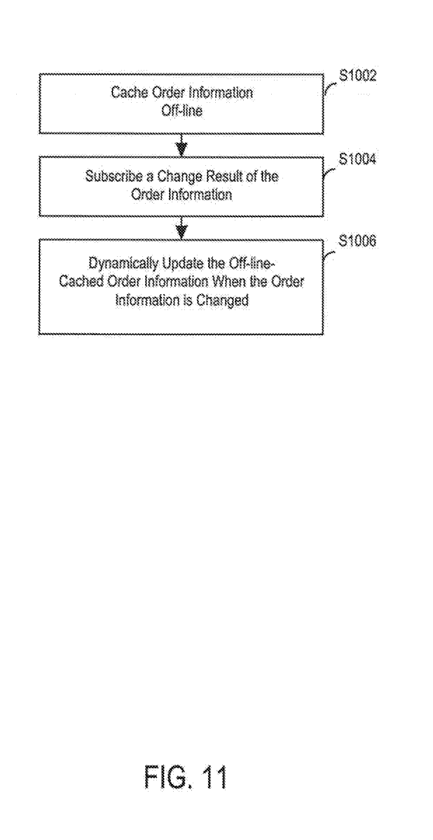

Optionally, FIG. 11 shows a flowchart of an optional article information displaying method. As shown in FIG. 11, before the telephone number used in current communication and the article information are displayed simultaneously in the recognition window of the communication interface, the method further includes the following steps:

Step S1002: Cashe order information offline.

Step S1004: Subscribe a changing result of the order information.

Step S1006: Dynamically update the offline-cached order information when the order information is changed.

In an optional embodiment, the user terminal caches order information of a client terminal for placing orders installed in the user terminal; the client terminal for placing orders registers to an order server by using identifier information (e.g., an ID of the client terminal for placing orders); and the order server subscribes for information changes in the order information (e.g., changes in logistics of commodity). When the logistics information of the commodity is changed, the logistics information is updated (e.g., “delivering” is updated to “received”), and the updated information is pushed to a third-party server. After receiving the updated logistics information, the third-party server pushes the logistics information to the client terminal that placed the order. When receiving the updated logistics information, the client terminal deletes the logistics state information “delivering” in the cache, and changes the state information to “received”. At the same time, each piece of information will be invalid after a predetermined time length (e.g., 24 hours) to ensure the information timeliness.

In another optional embodiment, the third-party server judges whether the subscribed changes in the logistics information of the client terminal for placing orders meet a predetermined condition. If the changes meet the predetermined condition, the third-party server updates order information of which logistics information is changed, and pushes the order information to an order server. The order information further includes an invalidation time of the order information. The order server extracts a courier service waybill number, a telephone number of a courier, and other information from the order information; and synchronously pushes the updated order information to the client terminal for placing orders according to identifier information of the client terminal for placing orders. At this time, if the logistics information of the client terminal for placing orders is “delivering”, the order information and the telephone number of the courier are stored in the cache; otherwise, if the logistics information of the client terminal for placing orders is “received”, the order information and the telephone number of the courier are deleted from the cache.

It should be noted that the user terminal caches the order information of the client terminal for placing orders installed in the user terminal. This accelerates the response speed of the user terminal when the courier calls, and at the same time can further solve the problem that the user cannot query order information due to the absence of network connection during calling or dialing.

It should also be noted that for ease of description, the foregoing method embodiments are described as a series of action combinations. However, those skilled in the art should know that the present invention is not limited to the described action sequence; some steps may be performed in another sequence or simultaneously according to the present invention. Next, those skilled in the art should also know that the embodiments described in the description are preferred embodiments, and the involved actions and modules are not necessarily needed for the present invention.

Through the description of the foregoing implementations, those skilled in the art can clearly understand that the method according to the embodiments can be implemented by software plus a necessary universal hardware platform. Definitely, the method may also be implemented by hardware, but the former is a better implementation in most cases. Based on such understanding, the technical solution of the present invention essentially, may be embodied in the form of a software product. The computer software product may be stored in a storage medium (such as a ROM/RAM, a magnetic disk, or an optical disc), and include several instructions that enable a terminal device (which may be a mobile phone, a computer, a server, a network device, or the like) to execute the methods in the embodiments of the present invention.

### Embodiment 2

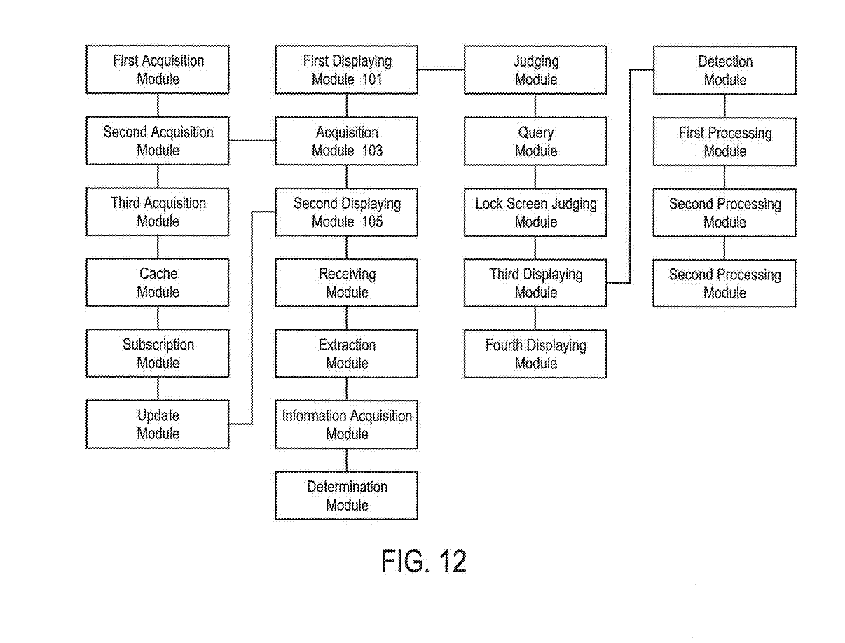

According to the embodiments of the present invention, an apparatus embodiment for implementing the article information displaying method is further provided. FIG. 12 is a schematic structural diagram of an article information displaying apparatus according to an embodiment of the present invention. As shown in FIG. 12, the apparatus includes: a first displaying module 101, an acquisition module 103, and a second displaying module 105.

The first displaying module 101 is configured to display a telephone number used in current communication on a communication interface of a user terminal.

In the step S202, the user terminal may be, but is not limited to, a hand-held device, a wearable device, and the like, or a smartphone and a tablet. When the user terminal is a smartphone, the communication interface of the user terminal may be the display interface used for making a call; and may also be a display interface of other means used by the user for communication. Other means may include, but are not limited to, short message, WeChat, QQ, and other means. FIG. 3 shows a schematic diagram of a communication interface of a user terminal. As shown in FIG. 3, the telephone number displayed on the display interface is the telephone number currently used for communicating with the user.

It should be noted that the telephone number used in current communication has been recorded at some websites, and has some special marks. For example, FIG. 4 shows an optional display interface of logistics information. A telephone number displayed in FIG. 4 has been recorded in logistics information of a commodity purchased by a user; and the telephone number is marked as the telephone number of a commodity deliverer in the logistics information.

The acquisition module 103 is configured to be used by the user terminal to acquire order information associated with the telephone number used in current communication, wherein the order information includes at least article information.

In an optional embodiment, the current calling telephone number is a telephone number of a courier who delivers goods for the user. When the courier calls with the current user or when the call has gone through but has not been answered, a terminal device (e.g., a smart phone) held by the user acquires, through the received telephone number, order information associated with the telephone number. Specifically, when the terminal device held by the user receives a call notification of the courier (at this time, the call has not gone through yet), the terminal device held by the user acquires a JingDong account of the user; obtains information of goods purchased by the user, i.e., order information, according to the JingDong account of the user and the telephone number of the courier; and displays the order information on a display interface of the terminal device held by the user.

It should be noted that the article information includes at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

The second displaying module 105 is configured to display the telephone number used in current communication and the article information on the communication interface of the user terminal, wherein the article information is displayed in a recognition window of the communication interface.

In an optional embodiment, after acquiring the telephone number used in current communication and the article information corresponding to the telephone number, the user terminal simultaneously displays the telephone number and the article information in the recognition window of the communication interface of the user terminal. In the interface shown in FIG. 3, dashed box 31 is an article information region in the recognition window, and dashed box 33 is a display region of the telephone number in the recognition window. If the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity is a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

By using the second displaying module 105, the user can view the current calling telephone number and information of the goods corresponding to the telephone number by using the communication interface of the user terminal. That is, when receiving a call or a short message from a courier, the user would learn relevant information of the commodity delivered by the courier before opening the package.

It can be appreciated from the above that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

In an optional embodiment, the apparatus further includes: a first acquisition module and a second acquisition module. The first acquisition module is configured to be used by the user terminal to acquire a local telephone number, wherein the local telephone number is combined with the telephone number used in current communication to determine the order information; the second acquisition module is configured to be used by the user terminal to acquire a login state of a registered user currently logging into a client terminal for placing orders, wherein if the login state indicates a successful login, order information for an order delivered to the registered user is queried, wherein the client terminal for placing orders is a client application installed in the user terminal.

In an optional embodiment, when the login state indicates an unsuccessful login or no order information for an order delivered to the registered user is obtained through querying, the user terminal acquires logistics information associated with the telephone number used in current communication from a third-party server.

In an optional embodiment, the apparatus further includes: a third acquisition module. The third acquisition module is configured to be used by the user terminal to click on the recognition window on the communication interface, acquire order information associated with the recognition window, and display the order information in a new pop-up interface, wherein the order information further includes at least logistics information of the order. If the article information has a predetermined type of information, the predetermined type of information in the article information is deleted, shielded, or encrypted.

In an optional embodiment, the apparatus further includes: a judging module and a query module. The judging module is configured to be used by the user terminal to judge whether order information associated with the telephone number is queried successfully. The query module is configured to be used by the user terminal to re-query order information matching the telephone number used in current communication if the query fails, wherein a re-query frequency is less than or equal to a predetermined number, and/or a time length consumed in re-querying is less than or equal to a predetermined time length.

In an optional embodiment, the apparatus further includes: a lock screen judging module, a third displaying module, and a fourth displaying module. The lock screen judging module is configured to judge whether a screen for displaying the communication interface is in a locked state. The third displaying module is configured to display information of a missed call in a notification bar if the screen is in a locked state. The fourth displaying module is configured to display information of a missed call in a pop-up window if the screen is not in the lock screen state.

In an optional embodiment, the apparatus further includes: a detection module, a first processing module, a second processing module, and a third processing module. The detection module is configured to detect whether a touch interface with the notification bar located therein receives a predetermined operation. The first processing module is configured to clear the notification bar or exit the notification bar if the predetermined operation is detected. The second processing module is configured to judge whether the screen is unlocked successfully if the predetermined operation is not detected. The third processing module is configured to display the missed call in the pop-up window, and clear the notification bar or exit the notification bar if the screen is unlocked successfully.

In an optional embodiment, if the notification bar displays information of a plurality of missed calls, it is judged whether abnormal information exists in the information of the plurality of missed calls.

In an optional embodiment, the apparatus further includes: a receiving module, an extraction module, a determination module, and an information acquisition module. The receiving module is configured to receive short message information. The extraction module is configured to extract, from the short message information, at least one or more types of order information as follows: the article information, pick-up information, and courier information. The determination module is configured to determine whether the order meets at least one predetermined condition according to the order information. The information acquisition module is configured to acquire a corresponding notification message if the order meets at least one predetermined condition, wherein the notification message carries different prompt information.

In an optional embodiment, if a plurality of pieces of successive short message information are received, the plurality of pieces of short message information are displayed in the notification bar; and if a plurality of pieces of short message information having identical content are received, only one of the plurality of pieces of short message information is displayed.

In an optional embodiment, the apparatus further includes: a cache module, a subscription module, and an update module. The cache module is configured to cache the order information offline. The subscription module is configured to subscribe a changing result of the order information. The update module is configured to dynamically update the offline-cached order information when the order information is changed.

### Embodiment 3

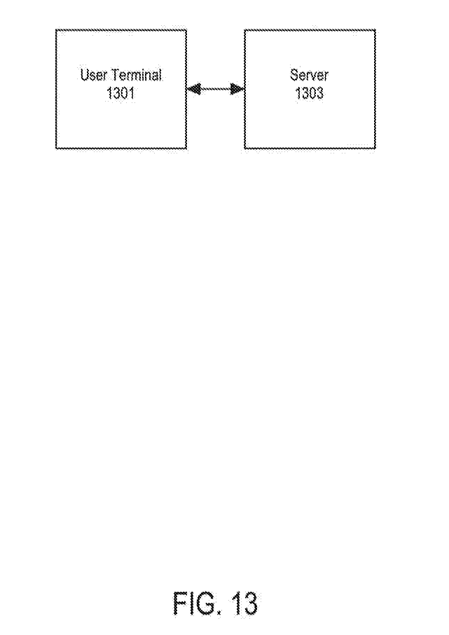

According to the embodiments of the present invention, a system embodiment for implementing the article information displaying method is further provided. As shown in FIG. 13, the system includes: a user terminal 1301 and a server 1303.

The user terminal 1301 is configured to display a telephone number used in current communication on a communication interface. The server 1303 has a communication relationship with a communication device and is configured to obtain order information associated with the telephone number used in current communication through querying; and return the order information to the user terminal, wherein the order information includes at least article information. The user terminal is further configured to simultaneously display the telephone number used in current communication and the article information on the communication interface, wherein the article information is displayed in a recognition window of the communication interface.

In an optional embodiment, the communication interface is a system interface provided by the user terminal or a message window provided by application software in the user terminal, wherein the application software is call software, instant messaging software, and short message and communication security monitoring software.

It can be appreciated from the above that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

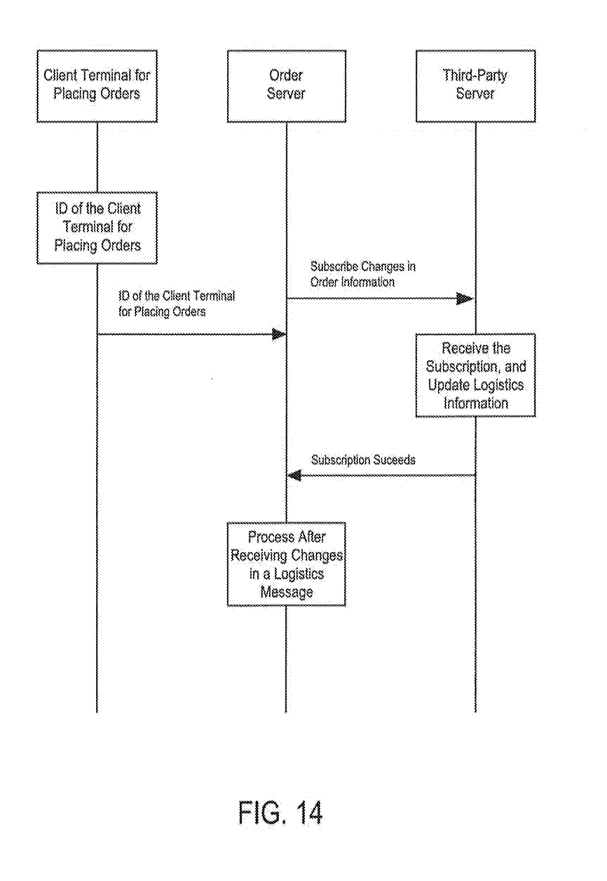

In an optional embodiment, as shown in a system interaction diagram of a subscribed logistics state change notification shown in FIG. 14, the user terminal caches order information of a client terminal for placing orders installed in the user terminal; the client terminal for placing orders registers to an order server by using identifier information (e.g., an ID of the client terminal for placing orders); and the order server subscribes for information changes in the order information (e.g., changes in logistics of commodity). When the logistics information of the commodity is changed, the logistics information is updated (e.g., “delivering” is updated to “received”), and the updated information is pushed to a third-party server. After receiving the updated logistics information, the third-party server pushes the logistics information to the client terminal that placed the order. When receiving the updated logistics information, the client terminal deletes the logistics state information “delivering” in the cache, and changes the state information to “received”. At the same time, each piece of information will be invalid after a predetermined time length (e.g., 24 hours) to ensure the information timeliness.

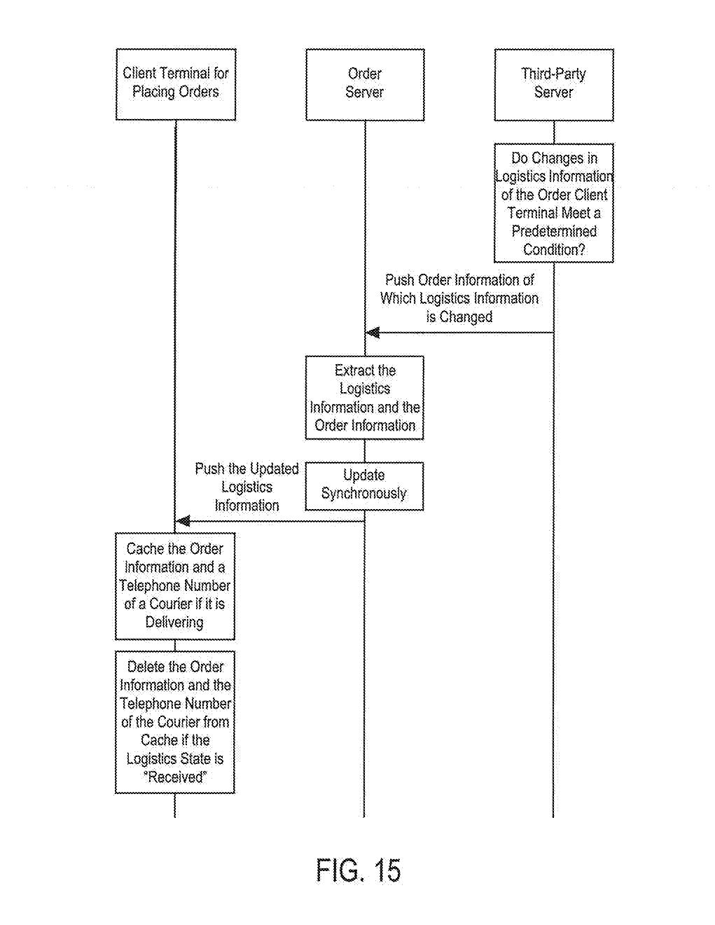

In another optional embodiment, as shown in a system interaction diagram of a subscribed logistics state change notification shown in FIG. 15, the third-party server judges whether the subscribed changes in the logistics information of the client terminal for placing orders meet a predetermined condition. If the changes meet the predetermined condition, the third-party server updates order information of which logistics information is changed, and pushes the order information to an order server. The order information further includes an invalidation time of the order information. The order server extracts a courier service waybill number, a telephone number of a courier, and other information from the order information; and synchronously pushes the updated order information to the client terminal for placing orders according to identifier information of the client terminal for placing orders. At this time, if the logistics information of the client terminal for placing orders is “delivering”, the order information and the telephone number of the courier are stored in the cache; otherwise, if the logistics information of the client terminal for placing orders is “received”, the order information and the telephone number of the courier are deleted from the cache.

### Embodiment 4

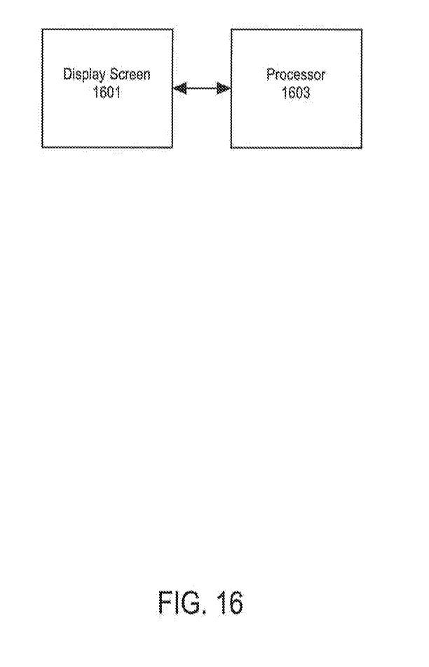

According to the embodiments of the present invention, an embodiment of an intelligent communication device is further provided. As shown in FIG. 16, the intelligent communication device includes: a display screen 1601 and a processor 1603.

The display screen 1601 is configured to provide a communication interface, and display a telephone number used in current communication on the communication interface. The processor 1603 is configured to acquire order information associated with the telephone number used in current communication, wherein the order information includes at least article information. The display screen is further configured to simultaneously display the telephone number used in current communication and the article information on the communication interface, wherein the article information is displayed in a recognition window of the communication interface.

It can be appreciated that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

### Embodiment 5

The embodiments of the present invention can provide a computer terminal. The computer terminal may be any computer terminal device in a computer terminal group. Optionally, in this embodiment, the computer terminal may also be replaced with another terminal device such as a mobile terminal.

Optionally, in this embodiment, the computer terminal may be located in at least one network device among a plurality of network devices of a computer network.

In this embodiment, the computer terminal can execute program code of the following steps in a vulnerability detection method of an application program: displaying a telephone number used in current communication on a communication interface of a user terminal; acquiring, by the user terminal, order information associated with the telephone number used in current communication, wherein the order information comprises at least article information; and simultaneously displaying the telephone number used in current communication and the article information on the communication interface of the user terminal, wherein the article information is displayed in a recognition window of the communication interface.

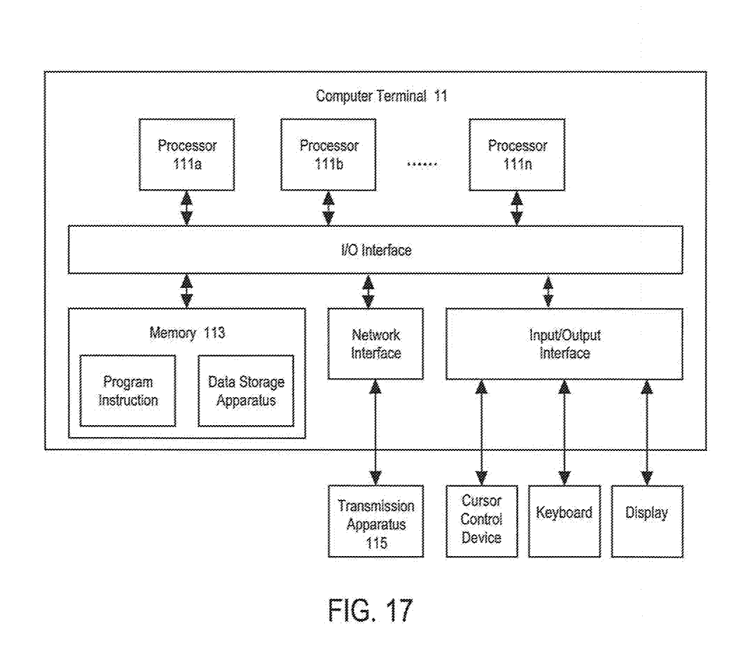

Optionally, FIG. 17 is a structural block diagram of a computer terminal according to an embodiment of the present invention. As shown in FIG. 17, a computer terminal 11 may include one or more (shown as 111a, 111b, . . . , 111n in the drawing) processors 111 (the processor 111 may include, but is not limited to, a processing apparatus such as a micro processor unit (MCU) or a programmable logic device (FPGA)), a memory 113 configured to store data, and a transmission apparatus 115 configured for a communication function. In addition, the computer terminal may further include: a display, an input/output interface (I/O interface), a universal serial bus (USB) port (which may be included as one port among ports of the I/O interface), a network interface, a power supply and/or a camera. Those of ordinary skill in the art can understand that the structure shown in FIG. 17 is merely schematic, and is not intended to limit the structure of the electronic device. For example, the computer terminal 11 may further include more or fewer components than those shown in FIG. 17, or have a configuration different from that shown in FIG. 17.

It should be noted that the one or more processors 111 and/or other data processing circuits may generally be referred to as “data processing circuits” in this text. The data processing circuit may be completely or partially embodied by software, hardware, firmware, or any other combination thereof. Moreover, the data processing circuit may be a single independent processing module, or may be completely or partially integrated in any of other elements in the computer terminal 11. As involved in the embodiment of the present application, the data processing circuit is used as a processor control (e.g., a selection of a variable resistance terminal path connected to an interface).

The memory 113 may be configured to store a software program and a module of application software, for example, a program instruction/data storage apparatus corresponding to the data sending and processing method in the embodiment of the present invention. The processor 111 runs the software program and module stored in the memory 113, thereby executing various function applications and data processing, i.e., implementing the data sending and processing method for the application program. The memory 113 may include a high-speed random access memory, and may also include a non-volatile memory, e.g., one or more magnetic storage apparatuses, a flash memory, or another non-volatile solid state memory. In some instances, the memory 113 may further include memories set remotely with respect to the processor 111. These remote memories may be connected to the computer terminal 11 through a network. Instances of the network include, but are not limited to, the Internet, an intranet, a local area network, a mobile communication network, and a combination thereof.

The transmission apparatus 115 is configured to receive or send data via a network. A specific instance of the network may include a wireless network provided by a communication provider of the computer terminal 11. In an instance, the transmission apparatus 115 includes a network interface controller (MC) that can be connected to another network device via a base station, thereby communicating with the Internet. In an instance, the transmission apparatus 115 may be a radio frequency (RF) module, configured to communicate with the Internet in a wireless manner.

The display may be, for example, a touch-screen type liquid crystal display (LCD). The liquid crystal display enables a user to interact with a user interface of the computer terminal 11.

It should be noted that in some optional embodiments, the computer terminal 11 shown in FIG. 17 may include a hardware element (including a circuit), a software element (including a computer code stored in a computer readable medium), or a combination of the hardware element and the software element. It should be pointed out that, FIG. 17 is merely an instance of a particular specific instance, and aims to show types of assemblies that may exist in the computer terminal.

By invoking the memory-stored information and application program through the transmission apparatus, the processor can perform the following steps: displaying a telephone number used in current communication on a communication interface of a user terminal; acquiring, by the user terminal, order information associated with the telephone number used in current communication, wherein the order information includes at least article information; and simultaneously displaying the telephone number used in current communication and the article information on the communication interface of the user terminal, wherein the article information is displayed in a recognition window of the communication interface.

Optionally, the processor may further execute program code of the following steps: acquiring, by the user terminal, a local telephone number, wherein the local telephone number is combined with the telephone number used in current communication to determine the order information; or, acquiring a login state of a registered user currently logging into a client terminal for placing orders by the user terminal, wherein if the login state indicates a successful login, order information for an order delivered to the registered user is queried, the client terminal for placing orders being a client application installed in the user terminal.

Optionally, the processor may further execute program code of the following steps: when the login state indicates an unsuccessful login or no order information for an order delivered to the registered user is obtained through querying, acquiring logistics information associated with the telephone number used in current communication from a third-party server by the user terminal.

Optionally, the processor may further execute program code of the following steps: clicking on the recognition window on the communication interface by the user terminal, acquiring order information associated with the recognition window, and displaying the order information in a new pop-up interface, wherein the order information includes at least logistics information of the order. If the article information has a predetermined type of information, the predetermined type of information in the article information is deleted, shielded, or encrypted.

Optionally, the processor may further execute program code of the following steps: judging, by the user terminal, whether order information associated with the telephone number is obtained successfully through querying; re-querying, by the user terminal, order information matching the telephone number used in current communication if the query fails, wherein a re-query frequency is less than or equal to a predetermined number, and/or a time length consumed in re-querying is less than or equal to a predetermined time length.

Optionally, the processor may further execute program code of the following steps: judging whether a screen for displaying the communication interface is in a locked state; displaying information of a missed call in a notification bar if the screen is in a locked state; and displaying information of a missed call in a pop-up window if the screen is not in the lock screen state.

Optionally, the processor may further execute program code of the following steps: detecting whether a touch interface with the notification bar located therein receives a predetermined operation; clearing the notification bar or exiting the notification bar if the predetermined operation is detected; judging whether the screen is unlocked successfully if the predetermined operation is not detected; and displaying the missed call in the pop-up window if the screen is unlocked successfully, and clearing the notification bar or exiting the notification bar.

Optionally, the processor may further execute program code of the following steps: if the notification bar displays information of a plurality of missed calls, judging whether abnormal information exists in the information of the plurality of missed calls.

Optionally, the processor may further execute program code of the following steps: receiving short message information; extracting, from the short message information, at least one or more types of order information as follows: the article information, pick-up information, and courier information; determining whether the order meets at least one predetermined condition according to the order information; and acquiring a corresponding notification message if the order meets at least one predetermined condition, wherein the notification message carries different prompt information.

Optionally, the processor may further execute program code of the following steps: if a plurality of pieces of successive short message information are received, displaying the plurality of pieces of short message information in the notification bar; and if a plurality of pieces of short message information having identical content are received, displaying merely one of the plurality of pieces of short message information.

Optionally, the processor may further execute program code of the following steps: offline caching the order information; subscribing a changing result of the order information; and dynamically updating the offline-cached order information when the order information is changed.

Those of ordinary skill in the art can understand that the structure shown in FIG. 17 is merely schematic. The computer terminal may also be a smart phone (e.g., an Android mobile phone, an iOS mobile phone, and the like), a tablet computer, a palmtop computer, and a terminal device such as mobile Internet devices (MIDs) and a PAD. FIG. 17 is not intended to limit the structure of the electronic device. For example, the computer terminal 11 may further include components (such as a network interface and a display apparatus) more or less than those shown in FIG. 17, or have a configuration different from that shown in FIG. 17.

Those of ordinary skill in the art can understand that all or part of steps in the methods of the above embodiment may be implemented by instructing hardware related to a terminal device by using a program. The program may be stored in a computer readable storage medium, and the storage medium may include: a flash memory, a read-only memory (ROM), a random access memory (RAM), a magnetic disk, an optical disc, or the like.

### Embodiment 6

The embodiments of the present invention further provide a storage medium. Optionally, in this embodiment, the storage medium may be configured to store program code executed by the article information displaying method provided in Embodiment 1.

Optionally, in this embodiment, the storage medium may be located in any computer terminal in a computer terminal group in a computer network, or located in any mobile terminal in a mobile terminal group.

Optionally, in this embodiment, the storage medium is configured to store program code for performing the following steps: displaying a telephone number used in current communication on a communication interface of a user terminal; acquiring, by the user terminal, order information associated with the telephone number used in current communication, wherein the order information includes at least article information; and simultaneously displaying the telephone number used in current communication and the article information on the communication interface of the user terminal, wherein the article information is displayed in a recognition window of the communication interface.

Optionally, in this embodiment, the storage medium is configured to store program code for performing the following steps: acquiring, by the user terminal, a local telephone number, wherein the local telephone number is combined with the telephone number used in current communication to determine the order information; or, acquiring a login state of a registered user currently logging into a client terminal for placing orders by the user terminal, wherein if the login state indicates a successful login, order information for an order delivered to the registered user is queried, the client terminal for placing orders being a client application installed in the user terminal.

Optionally, in this embodiment, the storage medium is configured to store program code for executing the following step: when the login state indicates an unsuccessful login or no order information for an order delivered to the registered user is obtained through querying, acquiring logistics information associated with the telephone number used in current communication from a third-party server by the user terminal.

Optionally, in this embodiment, the storage medium is configured to store program code for performing the following steps: clicking the recognition window on the communication interface by the user terminal, acquiring order information associated with the recognition window, and displaying the order information in a new pop-up interface, wherein the order information further includes at least logistics information of the order. If the article information has a predetermined type of information, the predetermined type of information in the article information is deleted, shielded, or encrypted.

Optionally, in this embodiment, the storage medium is configured to store program code for performing the following steps: judging, by the user terminal, whether order information associated with the telephone number is obtained successfully through querying; re-querying, by the user terminal, order information matching the telephone number used in current communication if the query fails, wherein a re-query frequency is less than or equal to a predetermined number, and/or a time length consumed in re-querying is less than or equal to a predetermined time length

Optionally, in this embodiment, the storage medium is configured to store program code for performing the following steps: judging whether a screen for displaying the communication interface is in a locked state; displaying information of a missed call in a notification bar if the screen is in a locked state; and displaying information of a missed call in a pop-up window if the screen is not in the lock screen state.

Optionally, in this embodiment, the storage medium is configured to store program code for performing the following steps: detecting whether a touch interface with the notification bar located therein receives a predetermined operation; clearing the notification bar or exiting the notification bar if the predetermined operation is detected; judging whether the screen is unlocked successfully if the predetermined operation is not detected; and displaying the missed call in the pop-up window if the screen is unlocked successfully, and clearing the notification bar or exiting the notification bar.

Optionally, in this embodiment, the storage medium is configured to store program code for executing the following step: if the notification bar displays information of a plurality of missed calls, judging whether abnormal information exists in the information of the plurality of missed calls.

Optionally, in this embodiment, the storage medium is configured to store program code for performing the following steps: receiving short message information; extracting, from the short message information, at least one or more types of order information as follows: the article information, pick-up information, and courier information; determining whether the order meets at least one predetermined condition according to the order information; and acquiring a corresponding notification message if the order meets at least one predetermined condition, wherein the notification message carries different prompt information.

Optionally, in this embodiment, the storage medium is configured to store program code for performing the following steps: if a plurality of pieces of successive short message information are received, displaying the plurality of pieces of short message information in the notification bar; and if a plurality of pieces of short message information having identical content are received, displaying only one of the plurality of pieces of short message information.

Optionally, in this embodiment, the storage medium is configured to store program code for performing the following steps: offline caching the order information; subscribing a changing result of the order information; and dynamically updating the offline-cached order information when the order information is changed.

### Embodiment 7

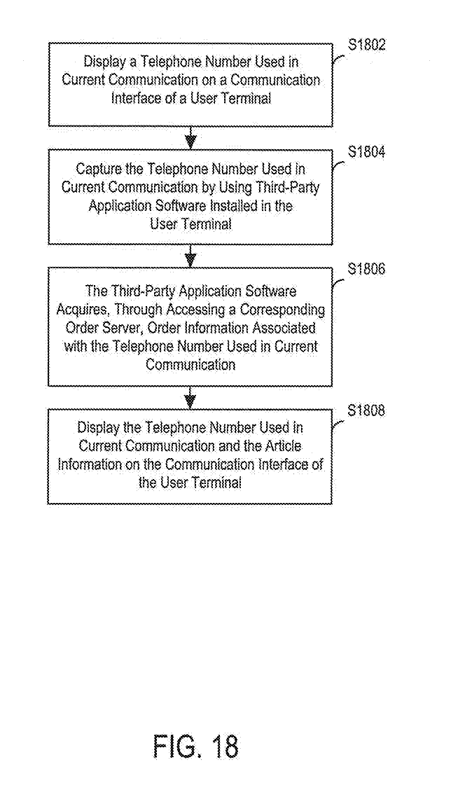

According to the embodiments of the present invention, an embodiment of an article information displaying method is further provided. FIG. 18 is a flowchart of an article information displaying method according to an embodiment of the present invention. As shown in FIG. 18, the method includes the following steps:

Step S1802: Display a telephone number used in current communication on a communication interface of a user terminal.

Step S1804: Capture the telephone number used in current communication by using third-party application software installed in the user terminal.

Step S1806: The third-party application software acquires, through accessing a corresponding order server, order information associated with the telephone number used in current communication, wherein the order information includes at least article information.

Step S1808: Display the telephone number used in current communication and the article information on the communication interface of the user terminal, wherein the article information is displayed in a recognition window of the communication interface.

In an optional embodiment, the user terminal may be, but is not limited to, a hand-held device, a wearable device, and the like, or a smartphone and a tablet. When the user terminal is a smart phone, the communication interface of the user terminal may be the display interface used for making a call; and may also be a display interface of other means used by the user for communication. Other means may include, but are not limited to, short message, WeChat, QQ, and other means.

In another optional embodiment, the current calling telephone number is a telephone number of a courier who delivers goods for the user. When the courier calls with the current user or when the call has gone through but has not been answered, a terminal device (e.g., a smart phone) held by the user acquires, through the received telephone number, order information associated with the telephone number. Specifically, when the terminal device held by the user receives a call notification of the courier (at this time, the call has not gone through yet), the terminal device held by the user acquires a JingDong account of the user; obtains information of goods purchased by the user, i.e., order information, according to the JingDong account of the user and the telephone number of the courier; and displays the order information on a display interface of the terminal device held by the user.

It should be noted that the article information includes at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

In another optional embodiment, if the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity is a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

Based on the solution disclosed in step S1802 to step S1808 in the above embodiment, it can be appreciated from the above that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

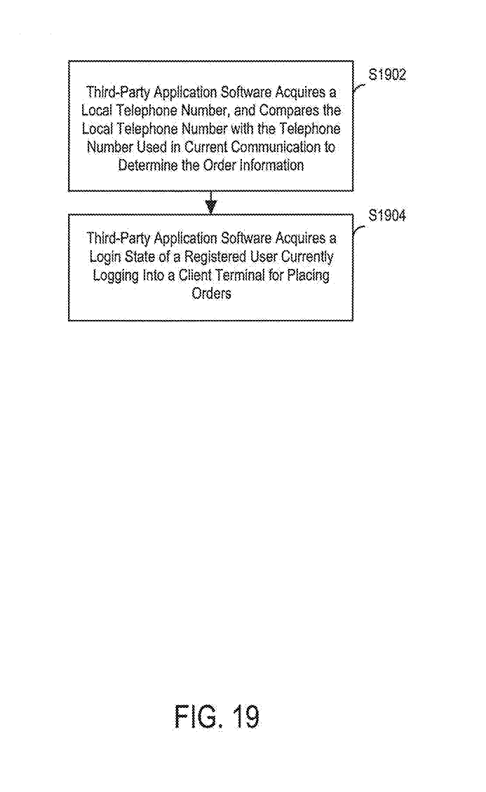

Optionally, according to an embodiment of the present application, a flowchart of an article information displaying method is provided. As shown in FIG. 19, the acquiring, by the third-party application software, order information associated with the telephone number used in current communication through accessing a corresponding order server includes the following steps:

Step S1902: The third-party application software acquires a local telephone number, and compares the local telephone number with the telephone number used in current communication to determine the order information; or,

Step S1904: The third-party application software acquires a login state of a registered user currently logging into a client terminal for placing orders, wherein if the login state indicates a successful login, the third-party application software queries order information for an order delivered to the registered user, wherein the client terminal for placing orders is a client application installed in the user terminal. When the login state indicates an unsuccessful login or no order information for an order delivered to the registered user is obtained through querying, the client terminal for placing orders extracts logistics information associated with the telephone number used in current communication.

In an embodiment, the user terminal (e.g., a smartphone) is installed with a client terminal for placing orders (e.g., a Jingdong client terminal). When the smartphone of a user detects information of an incoming call, a processor of the smartphone first judges whether a registered user of the Jingdong client terminal is in a login state. If the smartphone detects that the Jingdong client terminal is in a login state, the smartphone acquires order information of the registered user from logistics information of a commodity of the Jingdong client terminal according to a telephone number communicating with the smartphone. If the order information is not acquired, commodity information is not displayed; otherwise, information such as the commodity name is extracted from the order information; and it is determined whether the commodity is a sensitive commodity according to the information such as the commodity name. If the commodity is a sensitive commodity, commodity information after being desensitized is displayed in a recognition window of the smartphone. If the commodity is not a sensitive commodity, the usual commodity information is displayed in the recognition window of the smartphone.

It should be noted that the third-party application software is a type of software installed in the user terminal, and the third-party application software has functions such as capturing a telephone number and extracting content in a short message. The client terminal for placing orders may be, but is not limited to, a shopping client terminal (such as Jingdong and Suning), and a client terminal for ordering food (such as Meituan and Baidu Nuomi). The registered user of the client terminal for placing orders is not limited to the owner of the user terminal, and may also be another registered user having a registered account with the client terminal for placing orders.

In another optional embodiment, if the smartphone detects that the login state of the Jingdong client terminal indicates an unsuccessful login or does not find information associated with the telephone number of the incoming call by querying the order information of the client terminal for placing orders, the smartphone acquires logistics information of a plurality of commodities from a third-party server, and compares the telephone number of the incoming call with telephone numbers of couriers in the logistics information of the plurality of commodities. If the two telephone numbers match, information of the commodity associated with the telephone number of the incoming call is acquired; and the information is displayed in the recognition window of the smartphone. If it is detected that the commodity is a sensitive commodity, commodity information after being desensitized is displayed in the recognition window of the smart phone. It should be noted that in the above embodiment, the third-party server is a server other than the Jingdong server. That is, the third-party server is a server other than a server of the client terminal for placing orders.

Moreover, if the user terminal has poor network signal reception, and cannot return acquired commodity information in time, it is judged whether a time interval between receiving the incoming call by the user terminal and the displaying of the recognition window is greater than a preset time length (e.g., 5 s). If the time interval is greater than the preset time length, only a call type (e.g., a China Mobile user) is displayed on the communication interface of the user terminal without commodity information. If the user terminal acquires the commodity information, but the picture of the commodity is loaded slowly due to the slow speed of the Internet, in this case, only a default base map (i.e., a gray image having low pixels) is displayed in the recognition window of the user terminal.

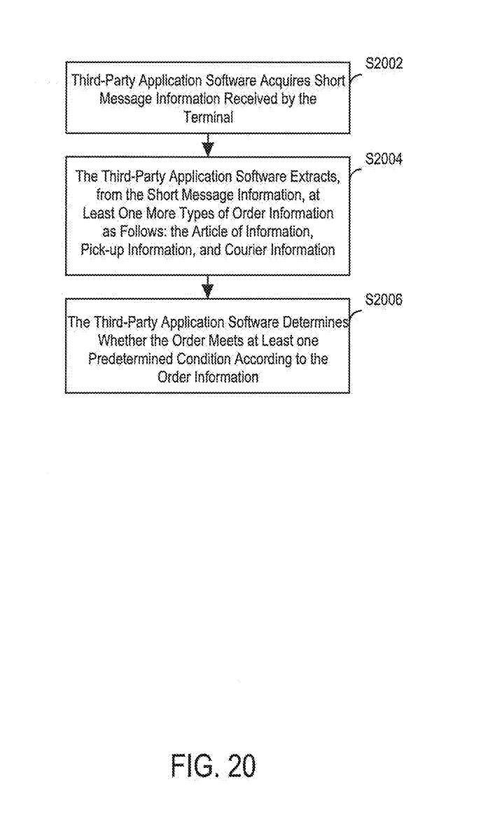

Optionally, according to an embodiment of the present invention, a flowchart of an article information displaying method is provided. As shown in FIG. 20, after the telephone number used in current communication and the article information are displayed simultaneously in the recognition window of the communication interface, the method further includes the following steps:

Step S2002: The third-party application software acquires short message information received by the user terminal;

Step S2004: The third-party application software extracts, from the short message information, at least one or more types of order information as follows: the article information, pick-up information, and courier information; and

Step S2006: The third-party application software determines whether the order meets at least one predetermined condition according to the order information; acquires a corresponding notification message if the order meets at least one predetermined condition, wherein the notification message carrying different prompt information.

In an embodiment, the third-party application software judges whether the short message information includes a pick-up code and whether the short message information is associated with the order information. Whether the short message information is associated with the order information may be judged in the following manner: if order information does not exist, it is preferred to query using a courier service waybill number; and if a courier service waybill number included in the short message information is the same as the courier service waybill number included in the order information, the short message information is associated with the order information. Alternatively, when only the courier service waybill number exists in the short message information, then an ID number of a client application is used for query, and a courier service waybill number in the application client terminal is compared with the courier service waybill number in the short message information. If the two telephone numbers match, the short message information is associated with the order information.

When the short message information is associated with the order information and if only the pick-up code exists in the short message information, the prompt information in the notification message is pick-up code prompt information. If both the pick-up code and the courier service waybill number exist in the short message information, the prompt information in the notification message includes pick-up code prompt information and to-be-delivered order prompt information. If only the courier service waybill number exists in the short message information, the prompt information in the notification message includes to-be-delivered order prompt information. If both pick-up code and courier service waybill number do not exist in the short message information, no message is prompted.

It should be noted that for a sensitive commodity, commodity information after being desensitized is displayed on the display interface of the user terminal.

Moreover, it should be further noted that from the time that a short message of courier information is received to the time the information is displayed on the display interface of the user terminal is a network request process. In the absence of a network connection, when extracting the short message information, the priority of extracting the short message information is higher than the priority of judging whether it is a local fraud.

In another optional embodiment, the user terminal caches order information of a client terminal for placing orders installed in the user terminal; the client terminal for placing orders registers to an order server by using identifier information (e.g., an ID of the client terminal for placing orders); and the order server subscribes for information changes in the order information (e.g., changes in logistics of commodity). When the logistics information of the commodity is changed, the logistics information is updated (e.g., “delivering” is updated to “received”), and the updated information is pushed to a third-party server. After receiving the updated logistics information, the third-party server pushes the logistics information to the client terminal that placed the order. When receiving the updated logistics information, the client terminal deletes the logistics state information “delivering” in the cache, and changes the state information to “received”. At the same time, each piece of information will be invalid after a predetermined time length (e.g., 24 hours) to ensure the information timeliness.

In another optional embodiment, the third-party server judges whether the subscribed changes in the logistics information of the client terminal for placing orders meet a predetermined condition. If the changes meet the predetermined condition, the third-party server updates order information of which logistics information is changed, and pushes the order information to an order server. The order information further includes an invalidation time of the order information. The order server extracts a courier service waybill number, a telephone number of a courier, and other information from the order information; and synchronously pushes the updated order information to the client terminal for placing orders according to identifier information of the client terminal for placing orders. At this time, if the logistics information of the client terminal for placing orders is “delivering”, the order information and the telephone number of the courier are stored in the cache; otherwise, if the logistics information of the client terminal for placing orders is “received”, the order information and the telephone number of the courier are deleted from the cache.

It should be noted that the user terminal caches the order information of the client terminal for placing orders installed in the user terminal. This accelerates the response speed of the user terminal when the courier calls, and at the same time can further solve the problem that the user cannot query order information due to the absence of network connection during calling or dialing.

### Embodiment 8

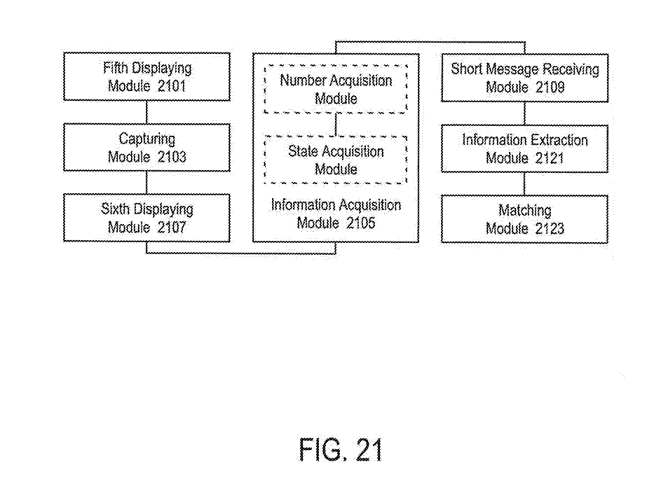

According to the embodiments of the present invention, an apparatus embodiment for implementing the article information displaying method is further provided. FIG. 21 is a schematic structural diagram of an article information displaying apparatus according to an embodiment of the present invention. As shown in FIG. 21, the apparatus includes: a fifth displaying module 2101, a capturing module 2103, an information acquisition module 2105, and a sixth displaying module 2107.

The fifth displaying module 2101 is configured to display a telephone number used in current communication on a communication interface of a user terminal. The capturing module 2103 is configured to capture the telephone number used in current communication by using third-party application software installed in the user terminal. The information acquisition module 2105 is configured to be used by the third-party application software to acquire order information associated with the telephone number used in current communication through accessing a corresponding order server, wherein the order information includes at least article information. The sixth displaying module 2107 is configured to display the telephone number used in current communication and the article information on the communication interface of the user terminal, wherein the article information is displayed in a recognition window of the communication interface.

In an optional embodiment, the user terminal may be, but is not limited to, a hand-held device, a wearable device, and the like, or a smartphone and a tablet. When the user terminal is a smartphone, the communication interface of the user terminal may be the display interface used for making a call; and may also be a display interface of other means used by the user for communication. Other means may include, but are not limited to, short message, WeChat, QQ, and other means.

In another optional embodiment, the current calling telephone number is a telephone number of a courier who delivers goods for the user. When the courier calls with the current user or when the call has gone through but has not been answered, a terminal device (e.g., a smart phone) held by the user acquires, through the received telephone number, order information associated with the telephone number. Specifically, when the terminal device held by the user receives a call notification of the courier (at this time, the call has not gone through yet), the terminal device held by the user acquires a JingDong account of the user; obtains information of goods purchased by the user, i.e., order information, according to the JingDong account of the user and the telephone number of the courier; and displays the order information on a display interface of the terminal device held by the user.

It should be noted that the article information includes at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

In another optional embodiment, if the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity is a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

It It can be appreciated that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

Optionally, the information acquisition module 2105 includes: a number acquisition module and a state acquisition module. The number acquisition module is configured to be used by the third-party application software to acquire a local telephone number, and compare the local telephone number with the telephone number used in current communication to determine order information; or to be used by the third-party application software to acquire a login state of a registered user currently logging into a client terminal for placing orders, wherein if the login state indicates a successful login, the third-party application software queries order information for an order delivered to the registered user, wherein the client terminal for placing orders is a client application installed in the user terminal. When the login state indicates an unsuccessful login or no order information for an order delivered to the registered user is obtained through querying, the third-party application software extracts logistics information associated with the telephone number used in current communication.

Optionally, the article information displaying apparatus further includes: a short message receiving module 2109, an information extraction module 2121, and a matching module 2123. The short message receiving module 2109 is configured to be used by the third-party application software to receive short message information. The information extraction module 2121 is configured to extract, by the third-party application software, at least one or more types of order information from the short message information: the article information, pick-up information, and courier information. The matching module 2123 is configured to be used by the third-party application software to determine whether the order meets at least one predetermined condition according to the order information; and acquire a corresponding notification message if the order meets at least one predetermined condition, wherein the notification message carries different prompt information.

### Embodiment 9

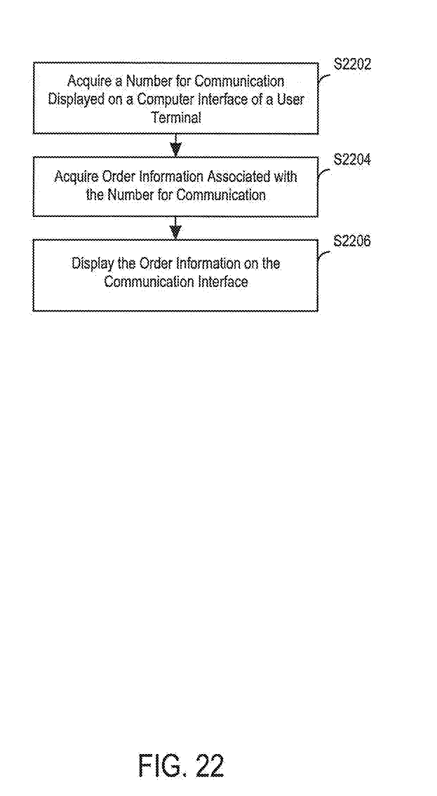

In accordance with embodiments of the present invention, an embodiment of an information displaying method is provided. FIG. 22 is a flowchart of an information displaying method according to an embodiment of the present invention. As shown in FIG. 22, the method includes the following steps:

Step S2202: Acquire a number for communication displayed on a communication interface of a user terminal.

In an optional embodiment, the number for communication may be, but is not limited to, a telephone number, a QQ number, a virtual number, and the like. The user terminal may be, but is not limited to, a hand-held device, a wearable device, and the like, or a smartphone and a tablet. When the user terminal is a smart phone, the communication interface of the user terminal may be the display interface used for making a call; and may also be a display interface of other means used by the user for communication. Other means may include, but are not limited to, short message, WeChat, QQ, and other means .

It should be noted that the number for communication displayed on the communication interface of the user terminal is a current calling telephone number.

Step S2204: Acquire order information associated with the number for communication, wherein the order information includes at least article information.

In an optional embodiment, the current calling telephone number is a telephone number of a courier who delivers goods for the user. When the courier calls with the current user or when the call has gone through but has not been answered, a terminal device (e.g., a smart phone) held by the user acquires, through the received telephone number, order information associated with the telephone number. Specifically, when the terminal device held by the user receives a call notification of the courier (at this time, the call has not gone through yet), the terminal device held by the user acquires a JingDong account of the user; obtains information of goods purchased by the user, i.e., order information, according to the JingDong account of the user and the telephone number of the courier; and displays the order information on a display interface of the terminal device held by the user.

It should be noted that the article information includes at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

Step S2206: Display the order information on the communication interface.

In an optional embodiment, after acquiring the telephone number used in current communication and the article information corresponding to the telephone number, the user terminal simultaneously displays the telephone number and the article information in the recognition window of the communication interface.

Optionally, if the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity is a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

By using the step S2206, the user can view the current calling telephone number and information of the goods corresponding to the telephone number by using the communication interface of the user terminal. That is, when receiving a call or a short message from a courier, the user can know relevant information of the commodity delivered by the courier before opening the package.

Based on the solution disclosed in step S2202 to step S2206 in the above embodiment, it can be appreciated that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

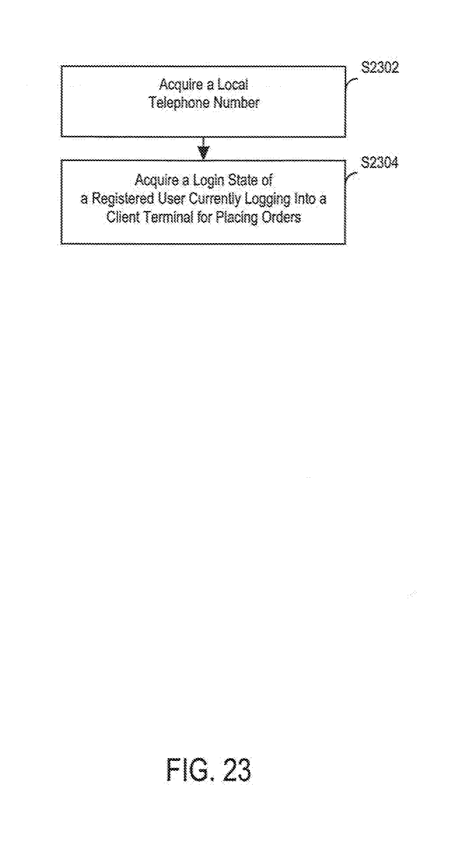

Optionally, according to an embodiment of the present application, a flowchart of an information displaying method is provided. As shown in FIG. 23, before the user terminal acquires the order information associated with the telephone number used in current communication, the method further includes the following steps:

Step 2302: Acquire a local telephone number, wherein the local telephone number is combined with the number for communication displayed on the communication interface to determine the order information; or,

Step S2304: Acquire a login state of a registered user currently logging into a client terminal for placing orders, wherein if the login state indicates a successful login, order information for an order delivered to the registered user is queried, wherein the client terminal for placing orders is a client application installed in the user terminal.

In an optional embodiment, the article information is stored or cached in the user terminal, wherein the telephone number of the deliverer is included in the article information stored or cached. For example, a user purchases a woollen shawl from JD.com; and at this time, a user terminal stores information of the commodity purchased by the user and updates logistics information of the woollen shawl in real time. When a courier starts the delivering process of the commodity for the user, the user terminal stores delivery information, wherein the delivery information includes at least a telephone number of the courier and a name of the to-be-delivered courier package. When the courier notifies the user to pick up the courier package, the user terminal compares the received telephone number of the courier with the stored telephone number of the courier who delivers the purchased commodity; and if the telephone numbers match and the commodity is not a sensitive commodity, the user terminal displays commodity information corresponding to the courier in a recognition window of the user terminal. At this time, if it is detected that the commodity is a sensitive commodity, commodity information after being desensitized is displayed in the recognition window of the user terminal.

FIG. 6 shows a flowchart of an optional article information displaying method. As shown in FIG. 6, in another optional embodiment, a user terminal (e.g., a smartphone) is installed with a client terminal for placing orders (e.g., a Jingdong client terminal). When the smartphone of a user detects information of an incoming call, a processor of the smartphone first judges whether a registered user of the Jingdong client terminal is in a login state. If the smartphone detects that the Jingdong client terminal is in a login state, the smartphone acquires order information of the registered user from logistics information of a commodity of the Jingdong client terminal according to a telephone number communicating with the smartphone. If the order information is not acquired, commodity information is not displayed; otherwise, information such as the commodity name is extracted from the order information; and it is determined whether the commodity is a sensitive commodity according to the information such as the commodity name. If the commodity is a sensitive commodity, commodity information after being desensitized is displayed in a recognition window of the smartphone. If the commodity is not a sensitive commodity, the usual commodity information is displayed in the recognition window of the smartphone.

It should be noted that the client terminal for placing orders may be, but is not limited to, a shopping client terminal (such as Jingdong and Suning), and a client terminal for ordering food (such as Meituan and Baidu Nuomi). The registered user of the client terminal for placing orders is not limited to the owner of the user terminal, and may also be another registered user having a registered account with the client terminal for placing orders.

On the basis of the method flowchart shown in FIG. 6, another optional embodiment is provided. If the smartphone detects that the login state of the Jingdong client terminal indicates an unsuccessful login or does not find information associated with the telephone number of the incoming call by querying the order information of the client terminal for placing orders, the smartphone acquires logistics information of a plurality of commodities from a third-party server, and compares the telephone number of the incoming call with telephone numbers of couriers in the logistics information of the plurality of commodities. If the two telephone numbers match, information of the commodity associated with the telephone number of the incoming call is acquired; and the information is displayed in the recognition window of the smart phone. If it is detected that the commodity is a sensitive commodity, commodity information after being desensitized is displayed in the recognition window of the smart phone. It should be noted that in the above embodiment, the third-party server is a server other than the Jingdong server. That is, the third-party server is a server other than a server of the client terminal for placing orders.

Moreover, if the user terminal has poor network signal reception, and cannot return acquired commodity information in time, it is judged whether a time interval between receiving the incoming call by the user terminal and the displaying of the recognition window is greater than a preset time length (e.g., 5s). If the time interval is greater than the preset time length, only a call type (e.g., a China Mobile user) is displayed on the communication interface of the user terminal without commodity information. If the user terminal acquires the commodity information, but the picture of the commodity is loaded slowly due to the slow speed of the Internet, in this case, only a default base map (i.e., a gray image having low pixels) is displayed in the recognition window of the user terminal.

### Embodiment 10

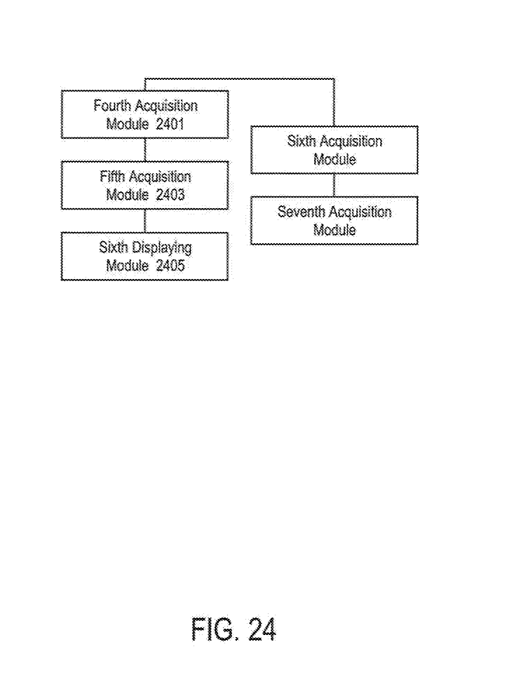

According to the embodiments of the present invention, an apparatus embodiment for implementing the information displaying method is further provided. FIG. 24 is a schematic structural diagram of an information displaying apparatus according to an embodiment of the present invention. As shown in FIG. 24, the apparatus includes: a fourth acquisition module 2401, a fifth acquisition module 2403, and a sixth displaying module 2405.

The fourth acquisition module 2401 is configured to acquire a number for communication displayed on a communication interface of a user terminal.

In an optional embodiment, the number for communication may be, but is not limited to, a telephone number, a QQ number, a virtual number, and the like. The user terminal may be, but is not limited to, a hand-held device, a wearable device, and the like, or a smartphone and a tablet. When the user terminal is a smartphone, the communication interface of the user terminal may be the display interface used for making a call; and may also be a display interface of other means used by the user for communication. Other means may include, but are not limited to, short message, WeChat, QQ, and other means.

It should be noted that the number for communication displayed on the communication interface of the user terminal is a current calling telephone number.

The fifth acquisition module 2403 is configured to acquire order information associated with the number for communication, wherein the order information comprises at least article information.

In an optional embodiment, the current calling telephone number is a telephone number of a courier who delivers goods for the user. When the courier calls with the current user or when the call has gone through but has not been answered, a terminal device (e.g., a smart phone) held by the user acquires, through the received telephone number, order information associated with the telephone number. Specifically, when the terminal device held by the user receives a call notification of the courier (at this time, the call has not gone through yet), the terminal device held by the user acquires a JingDong account of the user; obtains information of goods purchased by the user, i.e., order information, according to the JingDong account of the user and the telephone number of the courier; and displays the order information on a display interface of the terminal device held by the user.

It should be noted that the article information includes at least one of the following: the goods name, the goods picture, the goods order number, content category of the order, the logistics state (e.g., delivering or received), name of the courier company, the courier waybill number, contact information of the seller, data sources, and the like. When the user has questions about the received goods, the user can directly communicate with the seller by using the contact information of the seller in the article information, without the need of searching for the contact information of the seller from the website where the user purchases the goods.

The sixth displaying module 2405 is configured to display the order information on the communication interface.

In an optional embodiment, after acquiring the telephone number used in current communication and the article information corresponding to the telephone number, the user terminal simultaneously displays the telephone number and the article information in the recognition window of the communication interface.

Optionally, if the goods purchased by the user is a sensitive commodity, a desensitized processing is carried out on information of the commodity (for example, encrypting a commodity name and a commodity picture, e.g., carrying out mosaic processing or Gaussian blur processing on the commodity picture), or the commodity name is replaced with “secrete commodity” and the commodity picture is replaced with a default picture, before being displayed on the display interface of the user terminal.

It should be noted that the sensitive commodity is a category of commodities, such as underwear, body-shaping products, and adult products. By means of a data desensitized method, only the commodity information that has been desensitized is displayed in the recognition window. Moreover, the user may define display information in the recognition window of the communication interface to display a commodity category selected by the user and partial information of the commodity. For example, the user may set up the recognition window to display the commodity name only but not the picture. Desensitized data is one of the security technologies used for databases and refers to performing data deformation on some sensitive information (e.g., name information of some commodities) by using a desensitized rule, thereby implementing reliable protection on sensitive private data.

By using the sixth displaying module 2405, the user can view the current calling telephone number and information of the goods corresponding to the telephone number by using the communication interface of the user terminal. That is, when receiving a call or a short message from a courier, the user can know relevant information of the commodity delivered by the courier before opening the package.

It can be appreciated that the telephone number used in current communication is displayed on the communication interface; the order information associated with the telephone number used in current communication is acquired; and the telephone number used in current communication and article information are displayed simultaneously in the recognition window of the communication interface, wherein the order information includes at least the article information. It should be noted that the telephone number and the article information in the recognition window of the communication interface are associated with each other; and therefore, the user terminal can obtain the relevant information of the goods through querying according to the received telephone number. Moreover, the user terminal may also selectively display the article information of the goods of the terminal device, thereby further guaranteeing the privacy security of the user, and achieving the objective of quickly acquiring information of a courier-delivered product before the user receives the product. By displaying the calling telephone number and the article information on the communication interface, the present invention improves user experience, achieves its technical effect, and further solves the technical problem that a user cannot conveniently acquire information of a courier-delivered product before receiving the product.

In an optional embodiment, the apparatus further includes: a sixth acquisition module and a seventh acquisition module. The sixth acquisition module is configured to acquire a local telephone number, wherein the local telephone number is combined with the number for communication displayed on the communication interface to determine the order information; the seventh acquisition module is configured to acquire a login state of a registered user currently logging into a client terminal for placing orders, wherein if the login state indicates a successful login, order information for an order delivered to the registered user is queried, wherein the client terminal for placing orders is a client application installed in the user terminal.

In an optional embodiment, when the login state indicates an unsuccessful login or no order information for an order delivered to the registered user is obtained through querying, the user terminal acquires logistics information associated with the number for communication displayed on the communication interface of the user terminal from a third-party server.

Numbers of the embodiments of the present invention are merely used for description, and do not represent priorities of the embodiments.

In the above embodiments of the present invention, the descriptions on the embodiments have respective emphasis, and for parts that are not described in detail in an embodiment, reference may be made to related descriptions in other embodiments.

In the several embodiments described herein, it should be understood that, the disclosed technical content may be implemented in other means. The apparatus embodiment described in the foregoing is merely schematic. For example, the division of units is merely division of logic functions, and in fact, there may be other division means during implementation, for example, a plurality of units or components may be combined or may be integrated into another system, or some features may be omitted or not be executed. On the other hand, the displayed or discussed coupling or direct coupling or communication connection between them may be indirect coupling or communication connection implemented through some interfaces, units or modules, and may be in an electrical form or other forms.

Units described as separated parts may be or may not be physically separated, parts displayed as units may be or may not be physical units, and they may be located at the same place, or be distributed to a plurality of network units. The objective of the solution of this embodiment may be implemented by selecting a part of or all units thereof according to actual requirements.

In addition, various function units in the embodiments of the present invention can be integrated in one processing unit, each unit may also exist as a separated physical presence, and two or more units may also be integrated in one unit. The integrated unit may be implemented in a form of hardware, and may also be implemented in a form of a software function unit.

The integrated unit, if it is implemented in a form of a software functional unit and sold or used as an independent product, may be stored in a computer readable storage medium. Based on such an understanding, the technical solutions of the present invention essentially, or all or a part of the technical solution may be implemented in a form of a software product. The computer software product is stored in a storage medium, and includes several instructions for instructing a computer device (which may be a personal computer, a server, a network device, or the like) to execute all or a part of steps in the methods described in the embodiments of the present invention. The storage medium includes: a USB flash disk, a Read-Only Memory (ROM), a Random Access Memory (RAM), a mobile hard disk, a magnetic disk, an optical disc, or other mediums that can store program codes.

The above descriptions are merely preferred implementations of the present invention. It should be pointed out that, persons of ordinary skill in the art may further obtain several equivalent improvements and modifications without departing from the principle and scope of the present invention, and the improvements and modifications should be considered as falling within the protected scope of the present invention.

What is claimed is:

1. A communication device, comprising:
a display screen, configured to provide a communication interface and display on the communication interface a telephone number used in current communication; and
a processor, configured to acquire order information associated with the telephone number used in current communication, wherein the order information comprises at least article information; and wherein
the display screen is further configured to display simultaneously the telephone number used in current communication and the article information on the communication interface.

2. An article information displaying method, comprising:
displaying a telephone number used in current communication on a communication interface of a user terminal;
acquiring, by the user terminal, order information associated with telephone number used in current communication, wherein the order information comprises at least article information; and
displaying the telephone number used in current communication and the article information on the communication interface of the user terminal.

3. The method of claim 2, wherein before acquiring, by the user terminal, order information associated with the telephone number used in current communication, the method further comprises:
acquiring, by the user terminal, a local telephone number, wherein the local telephone number is combined with the telephone number used in current communication to determine the order information; or,
acquiring, by the user terminal, a login state of a registered user currently logging into a client terminal for placing orders, wherein if the login state indicates a successful login, order information for an order delivered to the registered user is queried, wherein the client terminal for placing orders is a client application installed in the user terminal, and wherein the article information is displayed in a recognition window of the communication interface.

4. The method of claim 3, wherein when the login state indicates an unsuccessful login or when no order information for an order delivered to the registered user is obtained through querying, the user terminal acquires logistics information associated with the telephone number used in current communication from a third-party server.

5. The method of claim 2, wherein after displaying the telephone number used in current communication and the article information on the communication interface of the user terminal, the method further comprises:
clicking, by the user terminal, the recognition window on the communication interface, acquiring order information associated with the recognition window, and displaying the order information on a new pop-up interface, wherein the order information comprises at least logistics information of the order,
wherein if the article information has a predetermined type of information, then deleting, shielding, or encrypting the predetermined type of information in the article information.

6. The method of claim 2, wherein the communication interface comprises a call interface, and a calling telephone stops ringing and enters a missed call state, wherein after displaying the telephone number used in current communication on the communication interface, the method further comprises:
judging, by the user terminal, whether order information associated with the telephone number used in current communication is obtained successfully through querying; and
re-querying, by the user terminal, order information associated with the telephone number used in current communication if the query fails,
wherein a re-query frequency is less than or equal to a predetermined number, and/or a time length consumed in re-querying is less than or equal to a predetermined time length.

7. The method of claim 6, wherein after the order information associated with the telephone number is obtained successfully through querying, the method further comprises:
judging whether a displaying screen for the communication interface is in a locked state;
displaying information of a missed call in a notification bar if the screen is in the locked state; and
displaying the information of the missed call in a pop-up window if the screen is not in the locked state.

8. The method of claim 7, wherein after displaying the information of the missed call in the notification bar, the method further comprises:
detecting whether a touch interface with the notification bar located therein receives a predetermined operation;
clearing the notification bar or exiting the notification bar if the predetermined operation is detected;
judging whether the screen is unlocked successfully if the predetermined operation is not detected; and
displaying the missed call in the pop-up window if the screen is unlocked successfully, and clearing the notification bar or exiting the notification bar.

9. The method of claim 7, wherein if the notification bar displays information of a plurality of missed calls, it is judged whether abnormal information exists in the information of the plurality of missed calls.

10. The method of claim 2, wherein after simultaneously displaying the telephone number used in current communication and the article information in the recognition window of the user terminal, the method further comprises:
receiving short message information;
extracting, from the short message information, at least one or more types of order information as follows: the article information, pick-up information, and courier information;
determining whether the order meets at least one predetermined condition according to the order information; and
acquiring a corresponding notification message if the order meets at least one predetermined condition, wherein the notification message carries different prompt information.

11. The method of claim 10, wherein if a plurality of successive pieces of short message information is received, the plurality of pieces of short message information are displayed in the notification bar; and if a plurality of pieces of short message information having identical content are received, only one of the plurality of pieces of short message information is displayed.

12. The method of claim 2, wherein before displaying the telephone number used in current communication and the article information in the recognition window of the communication interface, the method further comprises:
offline caching the order information;
subscribing a changing result of the order information; and
dynamically updating the offline-cached order information when the order information is changed.

13. An information displaying apparatus, comprising:
a first displaying module, configured to display a telephone number used in current communication on a communication interface of a user terminal;
an acquisition module, configured to be used by the user terminal to acquire order information associated with the telephone number used in current communication, wherein the order information comprises at least article information; and
a second displaying module, configured to simultaneously display the telephone number used in current communication and the article information on the communication interface of the user terminal.

14. An information displaying system, comprising:
a user terminal configured to display a telephone number used in current communication on a communication interface;
a server having a communication relationship with a communication device and configured to obtain order information associated with the telephone number used in current communication through querying, and return the order information to the user terminal, wherein the order information comprises at least article information; and
the user terminal being further configured to display the telephone number used in current communication and the article information on the communication interface.

15. The system of claim 14, wherein the communication interface is a system interface provided by the user terminal or a message window provided by application software in the user terminal, wherein the application software comprises call software, instant messaging software, and short message and communication security monitoring software, wherein the article information is displayed in a recognition window of the communication interface.

16. An information displaying method, comprising:
displaying a telephone number used in current communication on a communication interface of a user terminal;
capturing the telephone number used in current communication by using third-party application software installed in the user terminal;
acquiring, by the third-party application software, order information associated with the telephone number used in current communication through accessing a corresponding order server, wherein the order information comprises at least article information; and
displaying the telephone number used in current communication and the article information on the communication interface of the user terminal.

17. The method of claim 16, wherein the acquiring, by the third-party application software, order information associated with the telephone number used in current communication through accessing a corresponding order server comprises:
acquiring, by the third-party application software, a local telephone number, and compare the local telephone number with the telephone number used in current communication to determine the order information; or,
acquiring, by the third-party application software, a login state of a registered user currently logging into a client terminal for placing orders, wherein if the login state indicates a successful login, the third-party application software queries order information for an order delivered to the registered user, wherein the client terminal for placing orders is a client application installed in the user terminal, and
wherein when the login state indicates an unsuccessful login or no order information for an order delivered to the registered user is obtained through querying, the third-party application software extracts logistics information associated with the telephone number used in current communication, wherein the article information is displayed in a recognition window of the communication interface.

18. The method of claim 16, wherein after simultaneously displaying the telephone number used in current communication and the article information in the recognition window of the communication interface, the method further comprises:
acquiring, by the third-party application software, short message information received by the user terminal;
extracting, by the third-party application software from the short message information, at least one or more types of order information as follows: the article information, pick-up information, and courier information;
determining, by the third-party application software, whether the order meets at least one predetermined condition according to the order information; and acquiring a corresponding notification message if the order meets at least one predetermined condition, wherein the notification message carries different prompt information.

19. An information displaying apparatus, comprising:
a fifth displaying module, configured to display a telephone number used in current communication on a communication interface of a user terminal;
a capturing module, configured to capture the telephone number used in current communication by using third-party application software installed in the user terminal;
an information acquisition module, configured to be used by the third-party application software to acquire order information associated with the telephone number used in current communication through accessing a corresponding order server, wherein the order information comprises at least article information; and
a sixth displaying module, configured to display the telephone number used in current communication and the article information on the communication interface of the user terminal.

20. An information displaying method, comprising:
acquiring a number for communication displayed on a communication interface of a user terminal;
acquiring order information associated with the number for communication, wherein the order information comprises at least article information; and
displaying the order information on the communication interface.

21. The method of claim 20, wherein before acquiring the number for communication displayed on the communication interface of the user terminal, the method further comprises:
acquiring a local telephone number, wherein the local telephone number is combined with the number for communication displayed on the communication interface to determine the order information; or,
acquiring a login state of a registered user currently logging into a client terminal for placing orders, wherein if the login state indicates a successful login, order information for an order delivered to the registered user is queried, wherein the client terminal for placing orders is a client application installed in the user terminal, wherein the article information is displayed in a recognition window of the communication interface.

22. The method of claim 21, wherein when the login state indicates an unsuccessful login or no order information for an order delivered to the registered user is obtained through querying, the user terminal acquires logistics information associated with the number for communication displayed on the communication interface of the user terminal from a third-party server.

23. An information displaying apparatus, comprising:
a fourth acquisition module configured to acquire a number for communication displayed on a communication interface of a user terminal;
a fifth acquisition module configured to acquire order information associated with the number for communication, wherein the order information comprises at least article information; and
a sixth displaying module configured to display the order information on the communication interface.
